(19) United States
(12) Patent Application Publication
(10) Pub. No.: US 2023/0373011 A1
(43) Pub. Date: Nov. 23, 2023

(54) PARTING-BLADE CLAMP, PARTING-BLADE AND PARTING-BLADE HOLDER

(71) Applicant: ISCAR, LTD., TEFEN (IL)

(72) Inventors: ELY ERLICH, DURHAM (IL); GIL HECHT, VAIHINGEN-HORRHEIM (IL)

(73) Assignee: ISCAR, LTD., TEFEN (IL)

(21) Appl. No.: 18/044,610

(22) PCT Filed: Oct. 19, 2021
(86) PCT No.: PCT/IL2021/051236

§ 371 Date: Mar. 9, 2023

Related U.S. Application Data
(60) Provisional application No. 63/093,846, filed on Oct. 20, 2020.

(51) Int. Cl. B23B 29/04; B23B 27/08; B23B 27/16

(52) U.S. Cl. CPC B23B 29/043; B23B 27/086; B23B 27/1611; B23B 2200/0471

(57) ABSTRACT

A parting-off tool assembly including a blade holder, a parting-blade and a clamp. The clamp is secured to the blade-holder via a clamp attachment portion being fastened to the blade holder's holder attachment portion. The clamp also includes a clamp portion which abuts a peripheral edge of the parting-blade to secure the parting-blade to a blade-pocket of the blade holder.

### FIELD OF THE INVENTION

The subject matter of the present application relates to a parting-blade clamp (hereinafter also called “clamp” for conciseness) configured to clamp a parting-blade to a parting-blade holder (hereinafter also called “holder” for conciseness), the parting-blade holder, as well as a tool assembly comprising same, and methods of assembly and machining therewith.

### BACKGROUND OF THE INVENTION

The present application relates to a tool assembly for parting (also called “parting-off” or “cut-off”) operations. Nonetheless, it will be understood that a tool assembly which can carry out parting can also carry out grooving operations.

Traditional parting-blades are elongated to provide a large depth of cut capability. Typically, such a parting-blade is elongated with tapered longitudinal edges to allow strong clamping, while still able to be advantageously adjusted for different overhang lengths.

The present applicant has also further described parting tool assemblies in US 2019/0240741 assigned to the present applicant. In said publication, for example referring to FIGS. 17 to 20 therein, a square, regular-shaped, parting-blade and holder are described. Such tool assembly forgoes the advantage of adjustable overhang lengths for a more stable mounting arrangement.

Nonetheless, there are numerous features which could be improved in US 2019/0240741. For example, coolant is only provided to one side of the cutting insert due to the difficulty of providing coolant to both sides of the cutting insert in a regular-shaped blade with insert pockets on each corner (and the inlets of the blades being at a non-central position to maximize depth of cut). Additionally, the screws and plugs which are used to securely mount the blade cause a significant lateral projection preventing the blade from parting “close to shoulder”. Additionally, providing internal coolant holes in parting-blades is an expensive and difficult manufacturing task.

Regarding the provision of coolant, as with all machine tools, it is beneficial to cool a cutting insert during machining to increase the tool-life thereof.

Unlike other tools, there are unique difficulties in providing coolant to cutting inserts held by parting-blades. Namely, parting-blades are preferably as thin as possible (to reduce wastage of material) and enter deep within a workpiece. Provision of coolant is less effective with increased distance from a coolant outlet. Additionally, since the cutting insert is completely surrounded by the workpiece, it is not effective to provide a coolant nozzle at the side of the cutting insert. Further, chips flow above the cutting insert deflecting coolant from above.

Numerous solutions have been provided to overcome the above said difficulties. For example, in the past coolant was provided by an external conduit (used for many different tools) spaced apart from the parting-blade, however this is not particularly effective and chips and the workpiece obstruct coolant from reaching the cutting insert. One such solution is to form a coolant passageway within the parting-blade, and direct the coolant through the parting-blade itself, which as mentioned before is expensive. Another solution is to direct the coolant through the parting-blade and also through the cutting insert, which makes the production of the cutting insert complex. Yet another solution was to provide coolant only to a rear end of a cutting insert to avoid the coolant flow being obstructed by chips.

The most popular solution, recently, has been to provide high-pressure coolant through the parting-blade (most such blades and blade holders on the market being designated to provide coolant up to 70 bar, and the present Applicant's product is configured to provide coolant up to even 140 bar. However, while high pressure coolant through the blade overcomes the problem of allowing coolant to reach the essential area to be cooled, such passageways internal to the blade are produced through an expensive and slow manufacturing process. Since blades have a limited tool life and are then disposed of relatively quickly once the, typically resilient, insert pockets are worn, this makes the cost of such passageways in a disposable blade a significant consideration. Resilient insert pockets are typically used due to lack of room for screws in extremely thin, preferred, parting-blade widths.

While indexable inserts are an alternative to parting-blades, they are smaller due to the insert material being far more expensive than the typically steel blades, and it is difficult or impractical to press extremely large inserts. Since the cutting inserts are smaller, coolant supplied directly from a tool holder is more effective than it is for parting-blades with larger depths of cut (i.e. the cutting edge is comparatively further from the tool holder), and this is less of an issue. The present application is specifically directed to parting-blades due to the unique difficulty of providing effective coolant to a cutting edge a comparatively large distance from a tool holder.

It is an object of the present invention to provide an improved parting-blade clamp, parting-blade, parting-blade holder, and tool assembly comprising same.

### SUMMARY OF THE INVENTION

The present invention was developed as a coolant conduit configured to be mounted on a parting blade.

Stated differently, the present invention is a coolant conduit securely mounted on a parting blade such that the outlet thereof is proximate to the cutting insert to effectively provide coolant thereto.

The coolant conduit can comprise at least one extension portion thinner than the cutting insert cut width and thus a portion of the coolant conduit is configured to enter within the envelope of a narrow slit within the workpiece being parted and towards oncoming chips.

A number of unique safety mechanisms were developed to ensure that chips being machined would not dislodge or damage the coolant conduit.

Such coolant conduit was found to be advantageous of the above-mentioned regular-shaped blade concept with coolant only provided to one side. Additionally, since the coolant conduit does not undergo wear from machining forces (in contrast with parting blades with internal coolant holes) it can be remounted on many different parting blades, which are now cheaper and simpler to produce due to them not requiring internal coolant holes. Additionally, it was discovered that unlike the above-mentioned parting blades with coolant holes which are limited to at most 140 bar pressure, the coolant conduit can be supplied at an inlet thereof with higher coolant pressures (resulting in a greater coolant supply and hence cutting insert tool life is extended even more). Additionally, by elongating the cross section of a coolant passageway in a cutting plane, additional coolant can be provided through each outlet (compared with a traditionally circular conduit outlet). Additionally, the parting blade is stronger than one which has less material (due to the provision of voids, i.e. coolant holes) allowing maximum machining strength. Stated differently, the parting-blade can be devoid of coolant passageways. This is not to say that the coolant conduit cannot be used with a parting-blade having coolant passageways, but that one advantageous embodiment of the parting-blade is devoid of expensive internal coolant passageways, since the coolant conduit provides coolant.

Subsequent to the development of the coolant conduit, it was conceived to further combine the coolant conduit with an attachment portion. The attachment portion allows the above-described coolant conduit to be mounted on the parting-blade as well as providing a dual function to secure the parting-blade itself to a holder. The combined coolant conduit and clamp being called herein a “parting-blade clamp” or “clamp”. The clamp's attachment portion is called herein a “clamp attachment portion” or “attachment portion” for succinctness.

Subsequent to the development of the parting-blade clamp, it was discovered that the clamping features developed were independently advantageous over clamping of known blades, even without the provision of a coolant passageway through the clamp. For example, the parting-blade clamp is advantageous over even the Applicant's tool assembly in US 2019/0240741, as it is seemingly even more stable, provides no lateral projection as per the screwed blades mentioned above, allows a very quick indexing of the parting-blade, and requires fewer parts.

Further independently unique aspects developed are listed below.

According to an aspect of the present invention there is provided a parting-off tool assembly comprising: a blade holder; a parting-blade; and a clamp; the blade holder comprising: a holder attachment portion; and a blade-pocket; the parting blade is mounted to the blade-pocket and comprises: opposing first and second blade sides and a peripheral blade edge connecting the first and second blade sides; and at least a first insert pocket being formed along the peripheral blade edge; the peripheral blade edge comprising: first and second blade sub-edges extending from different sides of the first insert pocket; the clamp comprising: a clamp attachment portion; and at least one clamp portion comprising a clamp abutment surface; wherein: the clamp attachment portion is fastened to the holder attachment portion; the clamp abutment surface abuts the peripheral edge of the parting-blade thereby securing the parting-blade to the blade-pocket.

According to an aspect of the present invention there is provided a method of parting or grooving a slit in a workpiece with a tool assembly comprising: a first step of moving the tool assembly, relatively, towards a workpiece until the workpiece is contacted by a cutting edge of a cutting insert; a second step of moving the tool assembly, relatively, further towards the workpiece such that the cutting insert and a parting blade on which the cutting insert is mounted machine a slit in the workpiece; wherein during the second step a portion of a parting clamp enters the slit formed in the workpiece.

According to another aspect of the present invention there is provided a method of securing a parting blade to a blade holder; the method comprising providing a parting-blade clamp comprising an attachment portion and at least one clamp portion and a blade holder comprising an attachment portion, comprising: a first step of connecting the parting-blade clamp's attachment portion to the blade holder's attachment portion; a second step of mounting the parting-blade to a blade-pocket of the blade holder; and a third step of fastening the parting-blade clamp's attachment portion to the blade holder's attachment portion to bring the at least one clamp portion into abutment with a peripheral edge of the parting-blade thereby securing the parting-blade to the blade-pocket.

The at least one clamp portion can be two clamp portions located at different sides of the parting-blade.

The at least one clamp portion can be two clamp portions spaced-apart from each other.

The at least one clamp portion can comprise at least one clamp abutment surface, at least a portion of which extends within an extended-width cutting plane PC.

The at least one clamp abutment surface can be two clamp abutment surfaces, both of which extend in different directions within the extended-width cutting plane PC.

According to another aspect of the present invention there is provided a method of securing a parting-blade to a blade holder; the method comprising simultaneously wedging a parting-blade between two extension portions comprising mechanical interlocking structures against a pocket projecting edge.

The extension portions can be part of a single parting-blade clamp and the step of securing can be by moving the parting-blade clamp in a single direction. The single direction can be towards two adjacent sub-edges of the pocket projecting edge.

The parting-blade clamp can further comprise at least one, preferably two, clamping portions.

The pocket projecting edge can be formed with at least one mechanical interlocking structure, preferably two.

According to another aspect of the present invention there is provided a method of securing a parting-blade to a blade holder; the method comprising simultaneously wedging a parting-blade between two clamping portions comprising mechanical interlocking structures against a pocket projecting edge.

The clamping portions can be part of a single parting-blade clamp and the step of securing can be by moving the parting-blade clamp in a single direction. The single direction can be towards two adjacent sub-edges of the pocket projecting edge.

The parting-blade clamp can further comprise at least one, preferably two, extension portions.

The pocket projecting edge can be formed with at least one mechanical interlocking structure, preferably two.

According to another aspect of the present invention there is provided a parting-blade clamp comprising an attachment portion and at least one elongated extension portion; the extension portion defining an elongation direction within which a, extended-width cutting plane PC is defined; wherein the attachment portion is located outside of the cutting plane.

By “elongated” it is meant that that a maximum length LM of the extension portion is greater than a maximum height HE of the extension portion, i.e. fulfilling the condition: LM>HE.

It will be understood that while a greater maximum height HE allows a larger cross section (in the height direction) and therefore more coolant to be transferred through the extension portion, it requires a larger, less compact construction which can either limit cut depth or impede on the area needed for adjacent tool assemblies. Nonetheless, it has been found that the coolant conduit of the present invention provides ample coolant and hence it is preferred to configure the extension portions to allow the outlets thereof to be as close as possible to the cutting insert. Thus, it is even more preferred that the maximum length and maximum height fulfills the condition: LM>2HE, or even LM>2.5HE.

Nonetheless, in order to provide a reasonable amount of coolant, it is still preferred that each linear section (which is identified LM1 and LM3, respectively in FIG. 6C) of an extension portion located adjacent to the insert pocket, have a maximum length and maximum height fulfilling the condition: LM<8HE, preferably even LM<6HE and most preferably LM<5HE. Current optimal values for existing designs are 2.5HE<LM<4.5HE, however it should be understood that many design factors (such as parting-blade size) can alter this preferred range.

The at least one elongated extension portion can be two extension portions spaced-apart from each other.

The at least one elongated extension portion can extend within the extended-width cutting plane PC. An entirety of the elongated extension portion can extend within the extended-width cutting plane PC.

The at least one elongated extension portion can be two extension portions extending in different directions within the extended-width cutting plane PC.

The parting-blade clamp can be provided with a coolant passageway comprising an outlet opening out to the extension portion.

According to a third aspect of the present invention there is provided a parting-blade clamp comprising an attachment portion and at least one clamping portion; the clamping portion comprising a clamp abutment surface, at least a portion of which extends in an extended-width cutting plane PC; wherein the attachment portion is located outside of the extended-width cutting plane PC.

The at least one clamp portion can be two clamp portions spaced-apart from each other, each comprising a clamp abutment surface, both of the clamp abutment surfaces extending in different directions, at least partially located within the extended-width cutting plane PC.

The parting-blade clamp can comprise at least one extension portion extending from the clamp portion along the extended-width cutting plane PC.

The parting-blade clamp can be provided with a coolant passageway comprising an outlet opening out to the extension portion.

According to any of the aspects, the parting-blade clamp can preferably be configured with one or more of the following safety features.

An extension portion can comprise a safety projection or safety recess, preferably a safety projection. When mounted, a safety projection preferably is accommodated within a safety recess without contact.

An extension portion can preferably be biased against a parting-blade.

More preferably, the surfaces being biased can each comprise a mechanical interlocking structure.

An extension portion can be thinner than a parting-blade.

An extension portion can be elongated from a lower extension surface to an upper extension surface. This provides further structural strength than a mere cylindrical conduit, noting the unique space restrictions for parting or grooving applications.

An extension portion can be provided with a slanted front extension surface for deflecting oncoming chips. The slant could be defined relative to the direction of elongation or relative to an adjacent peripheral edge of a parting-blade, etc.

A front extension surface can be located a safe distance from an insert pocket for avoiding oncoming chips, even though such distance slightly reduces coolant effectiveness.

An extension portion can be coated to be heat or impact resistant.

According to any of the aspects, the parting-blade can preferably be configured with one or more of the following safety features.

A parting-blade's blade sub-edge can comprise a safety projection or safety recess, preferably a safety recess. When mounted, a parting-blade clamp's safety projection preferably is accommodated within a parting-blade's safety recess without contact. It will be understood that if the safety projection would contact the safety recess, this could reduce stability of the extension portion abutting the parting-blade. While it is feasible to design such contact if designed therefore (within acceptable design tolerances), it is currently preferred to avoid contact.

An extension portion can preferably be biased against a parting-blade's blade sub-edge.

A parting-blade's blade sub-edge can comprise a mechanical interlocking structure.

In accordance with another aspect of the present invention there is provided a parting-blade clamp comprising an attachment portion and a coolant passageway; the coolant passageway comprising an inlet, outlet and intermediary portion; the parting-blade clamp being a rigid body.

By rigid, it is meant that the coolant conduit has a basic shape unlike a flexible tube or pipe which adapts to the shape of a component it is held by.

The rigid body can preferably be made of metal, preferably steel.

The parting-blade clamp can be configured for direct connection to a supply pipe.

The parting-blade clamp can be figured to extend along two non-parallel blade-sub edges.

In accordance with another aspect of the present invention, there is provided a parting-blade comprising:
first and second blade sides and a peripheral blade edge connecting the first and second blade sides; and
a first insert pocket formed along the peripheral blade edge;
the peripheral blade edge comprising:
first and second blade sub-edges extending from different sides of the first insert pocket;
the first insert pocket comprising:
a base jaw;
a second jaw; and
a slot end connecting the base jaw and the second jaw;
   the base jaw is closer than the second jaw to the first blade sub-edge;
   the second jaw is closer than the base jaw to the second blade sub-edge;
   wherein at least one of the following two conditions is fulfilled:
a first condition wherein the second blade sub-edge is longer than the first blade sub-edge; and
the first blade sub-edge is formed with a first blade mechanical interlocking structure; and
a second condition wherein both the first blade sub-edge and the second blade sub-edge are both formed with a blade mechanical interlocking structure.

Generally speaking, introductory words such as “second” in the term “second mechanical interlocking structure” and similar words such as “first”, are to be considered identifying names only and are not meant to define a number of elements present.

Regarding the first condition: it will be understood that another way to state that the second blade sub-edge is longer than the first blade sub-edge is to say that the parting-blade is elongated along the second blade sub-edge. Stated differently, the parting-blade is elongated along the same direction as the base jaw. Hereinafter, such blades will be called x-axis blades.

X-axis blades are only known with a blade mechanical interlocking structure along their elongated side (i.e. along the second blade sub-edge and the sub-edge parallel thereto) which is intended for clamping the parting-blade to a blade holder. Accordingly, x-axis blades are only provided with a flat first blade sub-edge (are therefore devoid a blade mechanical interlocking structure along their first blade sub-edge).

To clarify, for the present invention, the function of a blade mechanical interlocking structure is not primarily for a traditional slanted blade holder jaw (such corresponding element being called a pocket projecting edge in the examples below) but another component as explained below. Thus, for example, a single blade mechanical interlocking structure could be provided to a parting-blade and the remainder (or a part of) the peripheral blade edge could be flat for abutment with a blade holder edge (also called a “pocket projecting edge” below), with one or more screws providing a lateral force on the parting-blade to keep it engaged with a blade holder support surface (also called a blade-pocket side surface below).

However, for parting-blades in which a blade mechanical interlocking structure is provided in any case, it is preferred that the blade mechanical interlocking structure to also provide a function of assisting in providing a lateral force and biasing the parting-blade towards a blade holder support surface.

Regarding the second condition: a less common parting-blade (hereinafter called Y-axis blades) exists in which the first blade sub-edge is longer than the second blade sub-edge (stated differently, elongated perpendicular to the base jaw.). Such Y-axis blades are only known with a blade mechanical interlocking structure along their elongated side (i.e. along the first blade sub-edge and the sub-edge parallel thereto) which is intended for clamping the parting-blade to a blade holder.

Hitherto both elongated X-axis and Y-axis blades are not known with blade mechanical interlocking structures along both sub-edges extending from different sides of an insert pocket. Needless to say, there is an expense involved in providing blade mechanical interlocking structures (which are typically ground), and hence such feature is not known because there has been no need therefore for traditional parting-blades which are clamped on opposing elongated sides of a parting-blade. Such traditional clamping allows the parting-blade overhang length to be beneficially variably changed as per user needs.

A more recent development of the present Applicant has been the development of parting-blades without variable overhang benefits. Such parting-blades are regular-shaped parting-blades (e.g. triangular, square, yet not elongated as per the x-axis and y-axis blades mentioned above) and are called hereinafter “regular-shaped blades”. The regular-shaped blades are not provided with any blade mechanical interlocking structure since lateral abutment forces are provided by screws extending through screw holes formed in the parting-blades and clamping the parting-blades to a blade holder. The provision of screws as a lateral support obviates the need for a blade mechanical interlocking structure and allows better force-support with the peripheral blade edge being flat. Furthermore, it is counterintuitive to have both a blade mechanical interlocking structure in combination with screws which are inserted laterally and therefore can even impede mounting the parting-blade to a blade holder edge.

As mentioned above, it is preferred that the blade mechanical interlocking structure to also provide a function of assisting in providing a lateral force and biasing the parting-blade towards a blade holder support surface. However, one of the concerns during development of parting-blades without lateral support in the form of a screw and screw hole system means (each screw providing hundreds of kilograms of force in the lateral direction) that there is an increased risk that the parting-blade will become detached from a blade holder support surface. However, testing has shown that the present system provides sufficient lateral support even when devoid of a centrally located securing arrangement. Nonetheless, there still may be some circumstances where one or more screws can be used in conjunction with such clamp abutment surface(s). In such case smaller screws or perhaps even one single small screw may be sufficient to overcome any clamping insufficiency in the lateral direction. Noting that a small screw will only have an undesirable lateral projection which is far smaller than the lateral projection of much larger screws of the prior art which bear the entire clamping force for a parting-blade.

It will be understood that non-blade aspects of the present invention could be used with blades of the prior art having only prior art blade mechanical interlocking structures or even only flat peripheral edges. This is because the blade mechanical interlocking structure is one of the optional yet preferred safety features for extension portions used for the present invention. For example, a parting-blade may be used with one of the non-blade aspects and be devoid of a blade mechanical interlocking structure in an embodiment where one or more extension portions have flat extension-abutment surfaces which are biased against corresponding flat peripheral edge abutment surfaces of a parting-blade, and one or more screws are provided to apply a lateral force to the parting-blade.

Nonetheless, for the present aspect in which at least one blade mechanical interlocking structure is provided, the following are preferred features.

The blade mechanical interlocking structure can extend along a majority of the sub-edge. Such feature allows both an extension mechanical interlocking structure and a clamp abutment surface to be laterally secured to a blade. Alternatively, such feature allows both an extension-abutment surface and a blade holder support surface to be laterally secured to a blade.

A forwardmost blade sub-edge can be formed with a blade mechanical interlocking structure (e.g. for x-axis blades, the forwardmost blade sub-edge is the first blade sub-edge; i.e. the blade sub-edge which is not elongated; or in cases of a regular-shaped blade the forwardmost blade sub-edge can be the sub-edge furthermost from a blade holder shank when the blade is mounted to the blade holder). As discussed above, known blades are not provided with blade mechanical interlocking structure at a side thereof that is not used for clamping to a blade holder.

Both the sub-edges extending from different sides of an insert pocket can be formed with a blade mechanical interlocking structure. As discussed above, known blades are not provided with blade mechanical interlocking structure at a side thereof that is not used for clamping to a blade holder.

The blade mechanical interlocking structure can be any mechanical structure which can apply a lateral force. Stated differently, the blade mechanical interlocking structure can be any mechanical structure other than a flat surface. More specifically, the blade mechanical interlocking structure comprises at least one blade sub-edge projection. More precisely, in a direction perpendicular to a thickness dimension there is at least one blade sub-edge projection. Some non-limiting, yet preferred examples of the at least one blade sub-edge projection are a single, central, blade sub-edge projection; or two or more blade sub-edge projections separated by a blade sub-edge recess located therebetween; a single non-central blade sub-edge projection; or more than one non-central blade sub-edge projections, located at different distances from an insert pocket. In each of the examples, there is an apex and at least one blade sub-edge abutment surfaces extending from the apex to one of the first and second blade sides. The blade sub-edge abutment surfaces can be convexly or concavely curved, yet are most preferably flat-slanted surfaces which allows precision grinding. To elaborate with respect to the most preferred embodiment there is a single, central, blade sub-edge projection (corresponding to a typical v-shaped cross section commonly used for longitudinal edges of parting-blades). This is because it provides equal lateral support to both sideways directions. More precisely, the single, central, blade sub-edge projection has an apex and has first and second blade sub-edge abutment surfaces extending from the apex to the first and second blade sides. Preferably, the first and second blade sub-edge abutment surfaces are flat-slanted surfaces which allows precision grinding. However, they could be convexly or concavely curved. A preferred internal blade angle α for the single, central, blade sub-edge projection fulfilling the condition: 120°≤α≤170% more preferably 140°≤α≤160% with values of α. While a typical internal blade angle α for a blade mechanical interlocking structure for a known x-axis blade is 150°, which is believed optimal for clamping, it may be that slightly smaller angles, e.g. 120°≤α≤148°, or 135°≤α≤145° are preferred for the blade mechanical interlocking structure of the present invention or at least a portion of the blade mechanical interlocking structure adjacent to an insert pocket, and/or for at least for a forwardmost blade sub-edge. This is in particular, beneficial for cases where the blade mechanical interlocking structure or portion thereof with such angle, is not used for clamping the parting-blade but is used for abutment with an extension-abutment surface. Notably, it is difficult to retain interlocking contact of a thin extension portion and a parting-blade, thus a more aggressive angle (i.e. the smaller angle ranges stated above) may be preferred. Nonetheless, in the shown prototype examples, the standard angle of 150° was found to work well. Preferably, the first and second blade sub-edge abutment surfaces extend at equal internal angles from the apex to the first and second blade sides. This allows the same blade to be used for similar effect for both right and left hand blade holders.

The blade mechanical interlocking structures of the parting-blade can have the same cross section. While a variable cross-section is possible, a uniform cross section allows for ease of production.

In accordance with another aspect of the present invention, there is provided a parting-blade comprising: first and second blade sides and a peripheral blade edge connecting the first and second blade sides; and a first insert pocket formed along the peripheral blade edge; the peripheral blade edge comprising: first and second blade sub-edges extending from different sides of the first insert pocket; wherein: at least one of the first blade sub-edge and the second blade sub-edge is formed with a blade safety recess.

Preferably, the first insert pocket comprises: a base jaw; a second jaw; and a slot end connecting the base jaw and the second jaw; the base jaw is closer than the second jaw to the first blade sub-edge; the second jaw is closer than the base jaw to the second blade sub-edge; wherein: the blade safety recess is formed on the second blade sub-edge.

Preferably, there is a blade safety recess formed on each of the first and second blade sub-edges.

Preferably, there is a blade safety recess formed on each of the first and second blade sub-edges.

Preferably, the blade safety recesses adjacent a common insert pocket are equally spaced therefrom.

The blade safety recess is a feature which allows an extension safety projection to extend into the blade's sub-edge to prevent oncoming chips from becoming wedged between the extension portion and blade, thereby displacing the extension portion.

The blade safety recess is most preferred for the second blade sub-edge (associated with the rake surface of a cutting insert mounted to the parting-blade, since the first blade sub-edge is adjacent the base jaw).

However, the blade safety recess can also be preferred for the first blade sub-edge for functions other than to prevent oncoming chips from being wedged as described above, such as providing a visual indicator for a user that the extension portion is correctly mounted to the thin blade. Stated differently, if a user observes the parting-blade from the side and the extension safety projection is located within the blade safety recess, it can be assumed the extension portion is correctly mounted.

Yet another benefit is that, where a parting-blade clamp has two extensions it can be designed symmetrically with each extension comprising an extension safety projection (and hence different parting-blade clamps are not needed for right and left hand blade holders).

It will be understood that non-blade aspects of the present invention could be used with blades of the prior art devoid of a blade safety recess. This is because the blade safety recess is one of the optional yet preferred safety features for extension portions used for the present invention.

Nonetheless, for the present aspect in which at least one blade safety recess is provided, the following are preferred features:
a. The blade safety recess can preferably be provided on the blade sub-edge adjacent the second blade sub-edge, for the reason described above.
b. The blade safety recess can preferably be first and second blade safety recesses, respectively provided on both the first and second sub-edges.
c. Where there is more than one blade safety recess on a single sub-edge, they can be located at equal distances from a sub-edge center. Stated differently, they can be symmetrically located along the sub-edge. Alternatively defined, the blade safety recesses adjacent a common insert pocket are equally spaced therefrom. This can provide the same advantage mentioned above of allowing a parting-blade clamp with two extensions to be designed symmetrically. Stated differently, the blade safety recess can preferably be within a recess length LR measured from the sub-edge at the insert pocket to the blade safety recess, fulfilling the condition: LR≤30 mm, preferably LR≤20 mm, most preferably LR≤15 mm. While the closer the blade safety recess and consequently the extension portion is to a cutting insert, the more effective the coolant will be, there is still a limitation of how close it can be located due to the danger of being impacted by chips or the workpiece (at the relief side). Accordingly, it is preferred that LR≥4 mm, preferably LR≥8 mm.
d. The blade safety recess can be located adjacent to the insert pocket. Stated differently, the blade safety recess can be located between an insert pocket and a sub-edge center.

In accordance with any parting-blade aspect or aspect comprising a blade, the following are preferred features:
a. The parting-blade can be a regular-shaped blade. This can allow a parting-blade clamp to be used to allow a design free of screws to be used (thereby reducing the lateral projection of a blade assembly etc.).
b. The parting-blade can be a solid parting-blade. By “solid” it is meant that the parting-blade is devoid of internal coolant channels. It will be understood that this allows a greatly simpler manufacturing process. However, it is feasible that a parting-blade may have a coolant channel to one side of an insert pocket (if it is difficult to provide an extension along that side of the parting-blade). In such case a blade assembly may have, for example, one extension providing coolant to one side of an insert pocket and an internal coolant channel providing coolant to the other side of the insert pocket (or to the cutting insert, e.g. through a hole in the cutting insert). In such case the internal coolant channel is preferably a straight through hole. At least in the case of a straight through hole a manufacturing process is at least simplified over known prior art with internal coolant channels since no plugging step is needed.
c. At least a portion of the parting-blade (adjacent to each insert pocket) is an elongated portion. A cutting insert configured to be mounted to the insert pocket having a cut width CW wider than a thickness dimension of the blade along the elongated portion, thereby allowing the elongated portion to enter a part of a workpiece being parted.
d. Each blade has a plurality of insert pockets. It will be understood that for each additional insert pocket the parting-blade is more economically efficient. However, it is most preferred for the parting-blade to have two to five insert pockets, more preferably, three or four insert pockets. It will be understood that for parting operations the chips involved need significantly more chip evacuation area than more circular slitting blades which can accommodate more than five insert pockets. Preferably, a parting-blade has an insert pocket formed at each corner thereof.
e. A blade can be devoid of screw holes. According to some preferred embodiments the parting-blade has a single central manufacturing hole. The central manufacturing hole allows the parting-blade to be rotated for the blade mechanical interlocking structures to be produced in a single mounted operation. Regardless, a blade can be devoid of threaded holes.
f. While the second jaw can feasibly be of the type located above the base jaw, as is typical for many insert pockets, it preferably is located rearward of the base jaw and extends oblique (basically perpendicular) thereto. This is because a second jaw which extends over the base jaw makes it more difficult for an extension to be aimed towards a cutting insert's cutting edge (requiring a steeper angle and thus the extension requires a greater height from the parting-blade). This consideration is only for an extension extending along a rake side of a parting-blade's sub-edge. Nonetheless, it should be clear that each type of known insert pocket is feasible with the present invention.
g. While each type of known insert pocket is feasible with the present invention, it is preferred for the parting-blade to have a resilient insert pocket (i.e. one which does not have a screw or lever to secure the screw). This is because parting operations are preferred to be carried out with a smaller cut width which wastes less material. It will be understood that the present invention, although most beneficial for parting, is also suitable for grooving and particular large depth grooving, without the final step of parting the workpiece.
h. Preferably the parting-blade's thickness dimension DT fulfils the condition: 0.8 mm≤DT≤4 mm, more preferably 1.2 mm≤DT≤3 mm and most preferably 1.4 mm≤DT≤2.5 mm. Regarding the lower end of the range (i.e. 0.8 mm) it will be understood that for coolant provision, integrally formed holes on blade holders can still provide effective coolant over small distances (e.g. 10-20 mm). Thus a significant advantage of a coolant extension is when it is more than 20 mm long. However there are cut depth/overhang limitations to how strong a thin parting-blade can be, thus it is not believed that a very long cut depth can be provided with less than 0.8 mm thickness. Additionally, noting that an extension portion preferably has an extension thickness TE less than the blade's thickness dimension DT (to provide relief) the amount of coolant provided at less than 0.8 mm would provide only a small effect. Regarding the upper end of the range, it is noted above that to reduce material wastage a blade's thickness dimension as small as possible is preferred. However, it is understood that a minimum thickness is still related to cut depth required.
i. For similar considerations to those mentioned regarding the parting-blade's thickness dimension DT, preferably a regular-shaped parting-blade has a sub-edge length LS fulfilling the condition: 30 mm≤LS≤80 mm, more preferably 40 mm≤LS≤70 mm and most preferably 45 mm≤LS≤60 mm. An alternative way to define the par regular-shaped parting-blade's size is by a circumscribing circle CC which contacts the peripheral blade edge. The circumscribing circle CC preferably fulfils the condition: 40 mm≤CC≤80 mm, more preferably 45 mm≤CC≤70 mm and most preferably 50 mm≤CC≤65 mm.
j. Regarding an elongated parting-blade has a sub-edge length LS along the smaller sub-edge (i.e. the sub-edge adjacent the base jaw for x-axis blades, and adjacent the second jaw for y-axis blades) fulfils the condition: 10 mm≤LS≤40 mm, more preferably 15 mm≤LS≤36 mm and most preferably 24 mm≤LS≤34 mm.
k. For similar considerations to those mentioned regarding the parting-blade's thickness dimension DT, preferably a cutting insert's cut width CW fulfils the condition: 1.0 mm≤CW≤5 mm, more preferably 1.4 mm≤CW≤4 mm and most preferably 1.6 mm≤DT≤3.2 mm.
l. For similar considerations to those mentioned regarding the parting-blade's size, preferably a parting assembly's depth of cut CD fulfils the condition: 40 mm≤CD≤160 mm, more preferably 50 mm≤CD≤140 mm and most preferably 60 mm≤CD≤125 mm.

It will be understood that for parting-blades formed within internal holes, additional material needs to be provided, at least at a rake side thereof to allow the hole to be directed towards a cutting edge. This means that on each side of an indexable parting-blade material is added increasing the size of the parting-blade. Thus the hole-free parting-blades of the present invention (but still providing high-pressure coolant adjacent to insert pockets) are smaller and therefore the blades themselves are structurally stronger (more able to resist bending).

Additionally, a parting-blade free of voids (i.e. coolant holes) is structurally stronger than a solid parting-blade.

According to another aspect of the present invention, there is provided a holder configured for securing a parting-blade thereto in the two-orthogonal directions.

More precisely, the holder comprises a blade-pocket configured for securing the parting-blade in both of two-orthogonal directions.

Preferably the parting-blade is indexable and comprises a plurality of insert pockets.

Preferably, the clamp is preferably configured to bias the adaptor into the corner of the blade-pocket.

Further to the above developments, it was found that such adaptor could be mistakenly be secured to the holder incorrectly (e.g. the adaptor could be secured to the holder for X-axis feed operations and then operated in the Y-axis direction). To prevent such occurrences, it was conceived to provide a mechanism to prevent incorrect assembly.

One preferred embodiment provides in the pocket a so-called “pocket projection” which projects into the blade-pocket and prevents a parting-blade from being incorrectly inserted therein (in the wrong orientation). Stated differently, the pocket projection can be accommodated in a recess of the parting-blade in one orthogonal orientation of the adaptor but not the other.

Preferably, the pocket projection is removable and re-attachable so that a user can use the alternative orientation when desired. In the example shown the pocket projection is a removable basically cylindrical or cylindrical pin.

Preferably, the recess of the adaptor has a non-cylindrical shape so the parting-blade can be easily placed on the blade-pocket.

Preferably, the recess of the parting-blade is an unused insert pocket, thus the parting-blade itself does not need to be provided with additional recesses which can weaken or complicate the construction thereof.

Preferably the parting-blade's bearing surfaces are mirror symmetric about an imaginary bisector pivot line extending through the two orthogonal positions.

The bisector line can extend through the forwardmost cutting edge of the insert.

Preferably the parting-blade's bearing surfaces are straight in side view.

Preferably the parting-blade has a quadrilateral, preferably regular quadrilateral and most preferably square shape in a side view.

In accordance with another aspect of the present invention there is provided a holder (not limited to a parting-blade holder) comprising an insert pocket or a blade-pocket with a magnet attached thereto.

The holder can comprise a blade-pocket, the blade pocket comprising: a blade-pocket side surface; a pocket projecting edge extending from the blade-pocket side surface; and a magnet attached to the blade-pocket surface.

Preferably the magnet is embedded within a blade-pocket side surface.

Preferably, for a blade-pocket, the magnet is made of neodymium. Initially it was conceived to use a ceramic magnet due to heat resistance capability. However, for a blade-pocket, the distance from the heated work area is considerable, leaving the heat capability consideration as secondary to the strength of the magnet. A stronger magnet means that less of the abutment area of the insert pocket is relinquished. Nonetheless all magnet types are possible.

For an insert-pocket, a ceramic magnet is preferred, however other magnet types may be possible.

In accordance with another aspect of the present invention there is provided a holder comprising a blade-pocket, the blade pocket comprising:
a blade-pocket side surface;
a pocket projecting edge extending from the blade-pocket side surface;
   the pocket projecting edge comprising a first abutment sub-surface and a second abutment sub-surface extending in a different direction to the first abutment sub-surface; and
   wherein both the first abutment sub-surface and a second abutment sub-surface are slanted towards the blade-pocket side surface.

The holder can comprise exactly one holder attachment portion configured for clamping a parting-blade thereto. The one holder attachment portion can a single threaded screw hole. The holder can further comprise a double-threaded right-left screw configured to be threaded to the threaded screw hole. The threaded screw hole can be located at the holder front surface.

It will be understood from the disclosure below that the parting-blade clamp can be devoid of an extension portion. The parting-blade clamp can comprise a single extension portion. The parting-blade clamp can comprise two extension portions extending in different directions to each other. According to any of these options the parting-blade clamp can be devoid of or have a coolant passageway.

It will be understood from the disclosure below that the parting-blade clamp can only provide an auxiliary clamping function and hence can be devoid of a clamping portion but can rather have at least one extension portion. Such parting-blade clamp can comprise two extension portions extending in different directions to each other. According to any of these options the parting-blade clamp can be devoid of or have a coolant passageway.

Noting that the clamping portions or extension portions can extend in different directions. The different directions can be a quarter turn.

It is also feasible for a tool assembly to comprising a first extension portion and a second extension portion not connected to each other. In other words, an assembly can comprise two parting-blade clamps according to the present invention, each comprising an extension portion.

It is also feasible for a tool assembly to comprise a parting-blade clamp according to the present invention, and a parting-blade with at least one internal coolant hole extending therethrough.

Regarding the shape of the parting-blade clamp:

It is preferred that at least an upper body surface (i.e. a forwardmost surface) is arc-shaped.

A preferred parting-blade clamp has two extension portions and is symmetrical about a symmetry plane PS extending through the center of the body portion thereof.

Regarding the shape of an extension portion:

It is preferred that an extension portion, or at least a portion thereof comprising an outlet, has a linear-shape. By linear or linear-shape, it is meant that when the extension portion is viewed in a side view, for example that shown in FIG. 6C, it extends in a straight line, even though the cross section thereof may vary.

Preferably the extension portion lies only in an extended-width cutting plane PC.

Preferably, the extension portion has an elongated extension cross section perpendicular to an elongation direction of the extension portion. Stated differently, preferably the elongated extension cross section is elongated in a direction from a lower extension surface to an upper extension surface.

Regarding the coolant passageway shape:

Preferably, the coolant passageway in the extension portion, perpendicular to an elongation direction of the extension portion, has an elongated passageway cross section. Stated differently, preferably the elongated passageway cross section is elongated in a direction from a lower extension surface to an upper extension surface.

Preferably an extension sub-passageway has a linear-shape.

Preferably, a coolant passageway, from the inlet, splits (or forks) in two different directions. The two directions can be opposite to each other.

According to another aspect of the present invention, there is provided a tool assembly comprising a blade holder, parting-blade and clamp; the clamp clamping the parting-blade to the blade holder; the parting-blade being formed with a first and second blade sub-edges extending from different sides of the first insert pocket; at least one of the first blade sub-edge and the second blade sub-edge is formed with a blade safety recess; the clamp comprises an extension portion formed with an extension safety projection; and wherein the extension safety projection is at least partially within the blade safety recess.

Preferably, there is a gap separating the blade safety recess and the extension safety portion.

According to another aspect of the present invention, there is provided a parting-blade clamp comprising: a body portion comprising a first body end, a second body end and an intermediary body sub-portion connecting the first end and second end; an attachment portion connected to the body portion; a first clamp portion connected to the first end; and a second clamp portion connected to the second end; the first clamp portion comprising a first clamp abutment surface; the second clamp portion comprising a second clamp abutment surface facing a second direction different to the first direction; the first and second clamp abutment surfaces are at least partially located within a cutting plane; the first clamp abutment surface faces a first direction; the second clamp abutment surface faces a second direction different to the first direction; and the intermediary body sub-portion is at least partially located outside of the cutting plane.

According to another aspect of the present invention, there is provided a parting-blade clamp comprising: a body portion comprising a first body end, a second body end and an intermediary portion connecting the first body end and second body end; an attachment portion connected to the body portion; at least a first clamp portion connected to the first body end; and a first extension portion connected to the first clamp portion; the first clamp portion comprising a first clamp abutment surface; and the entire first extension portion and at least a part of the first clamp abutment surface and are located within a cutting plane.

According to another aspect of the present invention, there is provided a parting-blade clamp comprising: a body portion comprising a first body end, a second body end and an intermediary portion connecting the first end and second end; an attachment portion connected to the body portion; a first extension portion extending from the first body end; and the entire first extension portion is located within a cutting plane and the intermediary body sub-portion is at least partially located outside of the cutting plane.

Preferably the parting-blade clamp comprises a clamp abutment surface and within the cutting plane.

Preferably the parting-blade clamp comprises two clamp abutment surfaces extending in different directions and within the cutting plane.

According to another aspect of the present invention, there is provided a parting-blade clamp comprising: a body portion comprising a first body end, a second body end and an intermediary portion connecting the first end and second end; an attachment portion connected to the body portion; a first extension portion extending from the first body end; and the entire first extension portion is formed with a mechanical interlocking structure.

According to another aspect of the present invention, there is provided a parting-blade clamp comprising: a body portion comprising a first body end, a second body end and an intermediary portion connecting the first end and second end; an attachment portion connected to the body portion; a first extension portion extending from the first body end; and an extension safety projection extends from the lower extension surface adjacent the front extension surface.

According to another aspect of the present invention, there is provided a tool assembly comprising a blade holder, parting-blade and clamp; the clamp clamping the parting-blade to the blade holder; the parting-blade being formed with a first clamp portion and a first extension portion extending from the first clamp portion; the first clamp portion clamping the parting-blade to the blade holder; the first extension portion being elongated along a common plane with the parting-blade.

According to another aspect of the present invention, there is provided a parting-blade clamp comprising: a body portion comprising a first body end, a second body end and an intermediary body sub-portion connecting the first end and second end; an attachment portion connected to the body portion; a first clamp portion connected to the first end; and a coolant passageway; the first clamp portion comprising a first clamp abutment surface; the coolant passageway comprising: an inlet; a first outlet; and an intermediary passageway extending from the inlet to the first outlet.

Preferably, the coolant passageway comprises at least two turns, more preferably three turns. Preferably, at least one turn is smoothly curved, more preferably the turns are all smoothly curved.

According to another aspect of the present invention, there is provided a method of mounting a parting-blade clamp to a parting-blade comprising: a first step of bringing an extension portion into contact with the parting-blade; and a second step of fastening the clamp/conduit to the parting-blade such that the extension portion flexes and a clamp abutment surface adjacent the extension portion comes into contact with the parting-blade.

According to another aspect of the present invention, there is provided a parting-blade clamp comprising a clamping portion and an extension portion extending therefrom and configured to flex; each of the clamping portion and the extension portion comprising abutment surfaces located in a common cutting plane; the extension portion's abutment surface being located relatively lower in the cutting plane such that when both of the abutment surfaces are brought to clamp a linear-shaped object the extension portion flexes.

According to another aspect of the present invention, there is provided a tool assembly comprising a blade holder, parting-blade and clamp; the clamp clamping the parting-blade to the blade holder; wherein the clamp is attached to the blade holder via a single screw.

Generally speaking, all element names hereinafter using numbering (e.g. “first”) are to be considered identifying names only and are not meant to define a number of elements present in the claims. For example, if a claim has an element the name of which includes “first” this does not imply that a “second” such element is required for the claim, rather that this is just a name. Similarly, the word “upper” or the like, is only to provide a definition relative to other elements of the same component and does not define the overall orientation of the component itself.

As is well known in the art, a rake surface is the surface above which machined chips are intended to flow and a clearance surface is typically designed to be receded from a cutting edge.

### BRIEF DESCRIPTION OF THE DRAWINGS

For a better understanding of the subject matter of the present application, and to show how the same may be carried out in practice, reference will now be made to the accompanying drawings, in which:

FIG. 1A is a perspective side view of a tool assembly according to the present invention;

FIG. 1B is a perspective exploded view of the tool assembly in FIG. 1A;

FIG. 2A is a side view of a parting-blade of the tool assembly in FIG. 1A;

FIG. 2B is a first end view of the parting-blade in FIG. 2A;

FIG. 2C is a second end view of the parting-blade in FIG. 2A;

FIG. 2D is a schematic representation of possible mechanical interlocking structures;

FIG. 2E is a schematic representation of structures devoid of a mechanical interlocking structure;

FIG. 2F is a schematic representation of possible mechanical interlocking structures;

FIG. 2G is a schematic representation of possible mechanical interlocking structures;

FIG. 2H is a schematic representation of possible mechanical interlocking structures;

FIG. 3A is a front view of a holder of the tool assembly in FIG. 1A;

FIG. 3B is a top view of the holder in FIG. 3A;

FIG. 3C is a side view of the holder in FIG. 3A;

FIG. 3D is a bottom view of the holder in FIG. 3A, also a machine interface is schematically shown;

FIG. 3E is a rear view of the holder in FIG. 3A;

FIG. 4A is a first end view of a clamp of the tool assembly in FIG. 1A;

FIG. 4B is another end view of the clamp in FIG. 4A;

FIG. 4C is a first side view of the clamp in FIG. 4A, with an alternative inlet circle shown schematically with a dashed line, and with a surface schematically identified with hatch lines for identification purposes only;

FIG. 4D is another end view of the clamp in FIG. 4A, and with a surface schematically identified with hatch lines for identification purposes only;

FIG. 4E is another end view of the clamp in FIG. 4A;

FIG. 4F is another side view opposite to the side view shown in FIG. 4C;

FIG. 5A is a view along both an attachment axis AA and an inlet axis AI of the clamp in FIG. 4A, with a coolant passageway being shown schematically with dashed lines;

FIG. 5B is a side view of the clamp in FIG. 5A, with the coolant passageway being shown schematically with dashed lines;

FIG. 6A is a front view of the tool assembly in FIG. 1A;

FIG. 6B is a top view of the tool assembly in FIG. 6A;

FIG. 6C is a side view of the tool assembly in FIG. 6A;

FIG. 6D is a bottom view of the tool assembly in FIG. 6A;

FIG. 6E is a rear view of the tool assembly in FIG. 6A;

FIG. 7A is an enlarged view of a portion of the tool assembly in FIG. 6C, schematically showing a portion of a cylindrical workpiece being parted with a dashed line;

FIG. 7B is a front view of the tool assembly in FIG. 7A, schematically parting the workpiece;

FIG. 7C is a top view of the tool assembly in FIG. 7B, schematically parting the workpiece;

FIG. 7D is a side view of the tool assembly in FIG. 7B, schematically parting the workpiece;

FIG. 8A is a perspective side view of another tool assembly according to the present invention;

FIG. 8B is a side view of the tool assembly in FIG. 8A, further showing a coolant hole option in dashed lines;

FIG. 9A is a side view of a parting-blade of the tool assembly in FIG. 8A;

FIG. 9B is a first end view of the parting-blade in FIG. 9A;

FIG. 9C is a second end view of the parting-blade in FIG. 9A;

FIG. 10A is a front view of a holder of the tool assembly in FIG. 8A;

FIG. 10B is a top view of the holder in FIG. 10A;

FIG. 10C is a side view of the holder in FIG. 10A;

FIG. 10D is a bottom view of the holder in FIG. 10A;

FIG. 10E is a rear view of the holder in FIG. 10A;

FIG. 11A is a first side view of a clamp of the tool assembly in FIG. 8A;

FIG. 11B is rear view of the clamp in FIG. 11A;

FIG. 11C is a top view of the clamp in FIG. 11A;

FIG. 11D is a front view of the clamp in FIG. 11A;

FIG. 11E is another side view of the clamp in FIG. 11A;

FIG. 11F is a bottom view of the clamp in FIG. 11A;

FIG. 12A is a first side view of the clamp in FIG. 11A, with a coolant passageway being shown schematically with dashed lines;

FIG. 12B is a top view of the clamp in FIG. 12A, with the coolant passageway being shown schematically with dashed lines;

FIG. 12C is a front view of the clamp in FIG. 12A, with the coolant passageway being shown schematically with dashed lines;

FIG. 13A is a front view of the tool assembly in FIG. 8A;

FIG. 13B is a bottom view of the tool assembly in FIG. 13A;

FIG. 13C is a side view of the tool assembly in FIG. 13A;

FIG. 13D is a top view of the tool assembly in FIG. 13A;

FIG. 13E is a rear view of the tool assembly in FIG. 13A;

FIG. 14A is a side view of another tool assembly according to the present invention; and

FIG. 14B is a perspective exploded view of the tool assembly in FIG. 14A.

### DETAILED DESCRIPTION

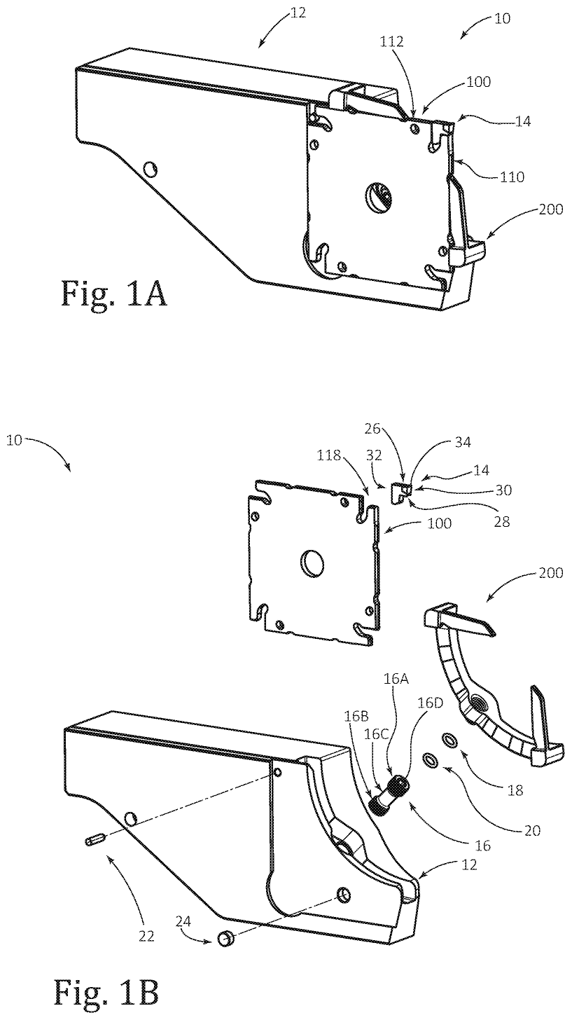

Referring to FIGS. 1A and 1B, there is illustrated an example tool assembly 10 comprising a holder 12, parting-blade 100 (with a cutting insert 14 mounted thereto) and parting-blade clamp 200 clamping the parting-blade 100 to the holder 12.

In this particular example, the tool assembly 10 further comprises a screw 16, first and second o-rings 18, 20 a pin 22 and a magnet 24, which will be described further hereinafter.

The cutting insert 14 comprises: a rake surface 26 and an opposing insert base surface 28, a forwardmost clearance surface 30 extending downwardly (as well as slightly inwardly) from the rake surface 26 towards the base surface 28 and an opposing insert rear surface 32, a forwardmost cutting edge 34 formed at an intersection of the rake surface 26 and the forwardmost clearance surface 30. Typically, the rake surface 26 comprises a chip forming arrangement (not shown).

The screw 16 comprises a first threaded end 16A, a second threaded end 16B and an intermediary screw portion 16C extending therebetween. The first threaded end 16A is a left-handed thread and also comprises a tool receiving recess 16D for receiving a screwdriver head (not shown). The second threaded end 16A is a right-handed thread.

Albeit that the double-threaded screw 16 is the preferred option, it will be understood that any attachment mechanism is suitable (lever, single threaded screw with or without spring, etc.). It should be noted though, that a significant advantage is provided by the capability to attach a clamp to the parting-blade and then detach it from the parting-blade and replace or index the parting-blade. Thus the attachment of the parting-blade clamp to the parting-blade is preferably temporary attachment or “attachable-detachable” (to differentiate over permanent attachment methods such as welding).

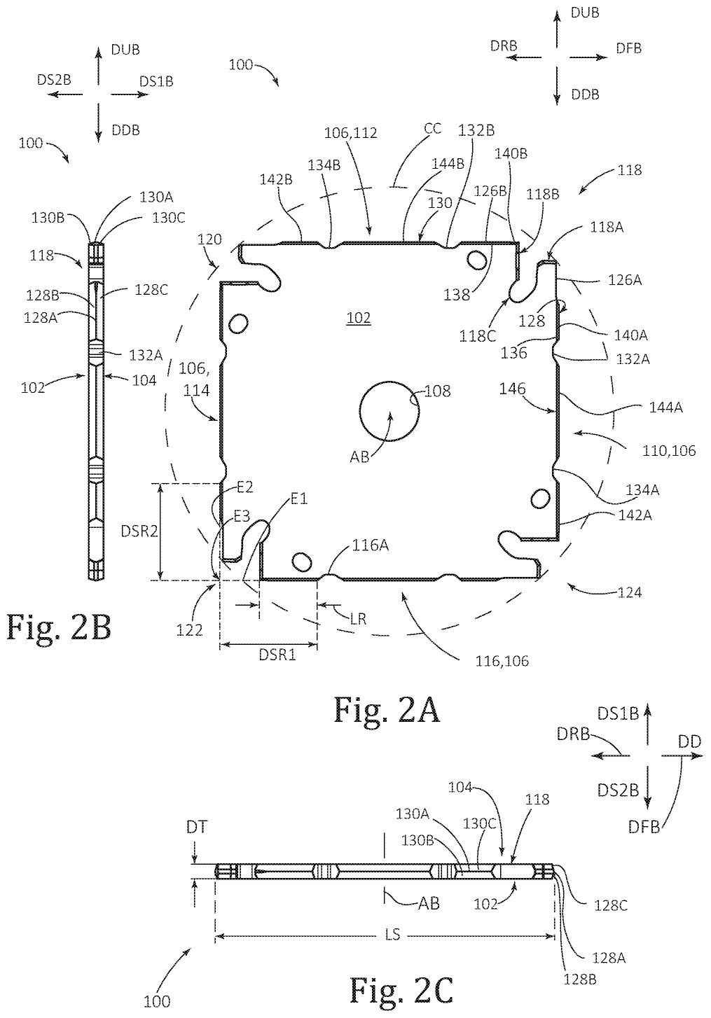

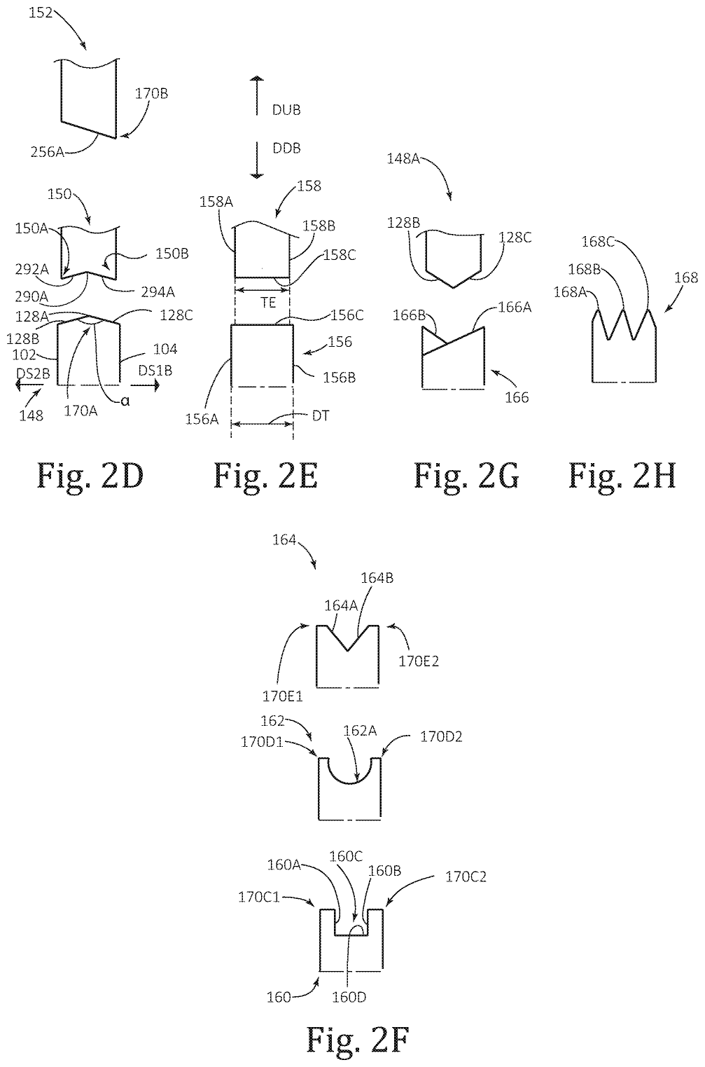

Referring to FIGS. 2A to 2C, the parting-blade 100 will be described.

The parting-blade 100 comprises first and second blade sides 102, 104 and a peripheral blade edge 106 connecting the first and second blade sides 102, 104.

In the given example, the entire parting-blade 100 has a uniform thickness, measured with a thickness dimension DT parallel to a blade axis AB extending through the center of the first and second blade sides. It will be understood that it is feasible to use known parting-blades which have a smaller thickness dimension proximate to an insert pocket and a larger thickness dimension (i.e. a reinforced portion) distal to said insert pocket. However, production of the present “planar-shaped” or “plate-shaped” parting-blade with a uniform thickness is simpler and hence preferred. It is also noted that the holder 12 and/or clamp 200 according to the present invention provides a parting-blade with better stability than any other tool assembly known to the applicant. For example, during experimentation, a tool assembly 10 as shown in FIG. 1A, successfully parted a standard steel workpiece having a diameter of 75 mm with a cut width CW of 1.6 mm with complete straightness.

Stated differently, the first and second blade sides 102, 104 are parallel to each other.

The parting-blade 100 can be formed with a central manufacturing hole 108 extending through the first and second blade sides 102, 104.

The peripheral blade edge 106 comprises first, second, third and fourth blade sub-edges 110, 112, 114, 116.

In the given example, each of the identical blade sub-edges has an identical sub-edge length LS measurable parallel to a given blade sub-edge and in an orthogonal direction to the blade axis AB. In other words, the parting blade 100 is square-shaped.

The exemplified blade is optionally yet preferably a regular-shaped indexable parting-blade (i.e. comprising more than one insert pocket) and hence the blade axis AB can also be considered an index axis about which the parting-blade can be indexed.

More precisely, the parting-blade 100 comprises first, second, third and fourth identical insert pockets 118, 120, 122, 124 formed along the peripheral blade edge.

The first insert pocket 118 of the four identical insert pockets will be exemplified below for explanation.

It is shown that the first insert pocket comprises a base jaw 118A, a second jaw 118B, and a slot end 118C connecting the base jaw 118A and the second jaw 118B.

Along the peripheral blade edge 106, adjacent to the base jaw 118A there is an external pocket relief surface (also called a “relief side”) 126A, and adjacent to the second jaw 118B there is an external pocket rake surface 126B (also called a “rake side”).

Using the first insert pocket 118 as an arbitrary reference, directions can be defined as follows.

A blade forward direction DFB extends from the third blade sub-edge 114 towards the first blade sub-edge 110, a blade rearward direction DRB opposite to the blade forward direction DFB, a blade upward direction DUB extending perpendicular to the blade forward direction and from the fourth blade sub-edge 116 towards the second blade sub-edge 112, a blade downward direction DDB opposite to the blade upward direction DUB, a blade first side direction DS1B extending perpendicular to the blade forward direction DFB and from the first blade side 102 towards the second blade side 104, and a blade second side direction DS2B opposite to the blade first side direction DS1B.

The blade forward direction DFB constitutes a feed direction in which direction the tool assembly 10 is moved relative to a workpiece for a parting operation. As will be explained below, the directions defined here for the parting-blade will correspond to the directions defined below for the holder 12 when the tool assembly 10 is assembled.

Notably, the first and second blade sub-edges 110, 112 extend from different sides of the first insert pocket 118. More specifically, the first blade sub-edge 110 extends in the blade downward direction DDB from the first insert pocket 118 and the second blade sub-edge 112 extends in the blade rearward direction DRB from the first insert pocket 118.

The first blade sub-edge 110 is formed with a first blade mechanical interlocking structure (‘interlocking formation”) 128. It will be understood that when the cutting insert 14 is mounted to the first insert pocket, the machining direction is the blade forward direction DFB and hence the first blade sub-edge 110 is a so-called forwardmost blade sub-edge.

The preferred first blade mechanical interlocking structure 128 is a convex, v-shaped, cross section commonly used for longitudinal edges of parting-blades. More precisely, the first blade mechanical interlocking structure 128 comprises a central apex 128A and first and second blade sub-edge abutment surfaces 128B, 128C extending from the apex, at an internal blade angle α as seen in FIG. 2D, to the first and second blade sides 102, 104.

As the parting-blade 100 is four-way rotationally symmetric (i.e. 90 degree rotational symmetry) all of the sub-edges in the example are identical, and therefore the second blade sub-edge 112 is formed with a second blade mechanical interlocking structure 130 identical to the first blade mechanical interlocking structure described above. More precisely, the second blade mechanical interlocking structure comprises a central apex 130A and first and second blade sub-edge abutment surfaces 130B, 130C extending from the apex to the first and second blade sides 102, 104.

Each blade sub-edge is provided with two blade safety recesses. The first blade sub-edge 110 is formed with a first blade safety recess 132A adjacent the first insert pocket 118 and a second blade safety recess 134A adjacent the fourth insert pocket 124. As shown in FIG. 2A, the first and second blade safety recesses 132A, 134A extend more in the rearward direction than a rearwardmost point 136 of the first blade sub-edge 110 located between the first insert pocket 118 and the first blade safety recess 132A.

Similarly, the second blade sub-edge 112 is formed with a first blade safety recess 132B adjacent the first insert pocket 118 and a second blade safety recess 134B adjacent the second insert pocket 120. As shown in FIG. 2A, the first blade safety recess 132B extends more in the downward direction DDB than a forwardmost point 138 of the second blade sub-edge 112 located between the first insert pocket 118 and the first blade safety recess 132B.

Thus, when an oncoming chip comes towards the clamp 200, it cannot become jammed between an extension safety projection extending into a safety recess because the sub-edge above which it passes is higher than the start of the extension portion in the safety recess.

It will be understood that the first blade safety recess of the first blade sub-edge and the first blade safety recess of the second blade sub-edge are the only blade safety recesses functionally related to the first insert pocket. To elaborate, for example, the second blade safety recess of the second blade sub-edge will be used when a cutting insert is mounted to the second insert pocket, etc. It is thus understood that the designation “first”, as applied to the blade safety recesses, is associated with the blade safety recesses closest to an operative insert pocket. Thus, if the parting-blade seen in FIG. 2A were rotated 90° clockwise and insert pocket 120 occupied the position currently occupied by insert pocket 118, then what is currently “second blade safety recess 134B” would be considered “first blade safety recess 134B”.

More precisely, while the first blade mechanical interlocking structure 128 is considered to extend along the entire first sub-edge 110 (i.e. the majority thereof excluding small interruptions as discussed below), theoretically, the first blade mechanical interlocking structure 128 can be considered to comprise three sub-structures, a first sub-structure 140A (or “first sub-formation”) proximate to the first insert pocket 118, a second sub-structure 142A (or “second sub-formation”) adjacent to the fourth insert pocket 124, and a third sub-structure 144A (or “third sub-formation”) located between the first and second sub-structures 140A, 142A. Thus, as seen in FIG. 2A, each blade sub-edge 110, 112, 114, 116 is interrupted by two spaced-apart blade safety recesses.

Only the first sub-structure is functionally related to the first insert pocket. One reason for provision of the entire sub-edge with such feature is that the second sub-structure can be abutted when a cutting insert is mounted to the fourth insert pocket. Another reason is that the second sub-structure can be abutted simultaneously with the first sub-structure in embodiments where a parting-blade clamp comprises a clamp abutment surface. A reason for the third sub-structure is for ease of production. In any case, it is feasible that a first mechanical interlocking structure extend only adjacent to the associated insert pocket (thus the first sub-edge could theoretically only comprise the first sub-structure 140A).

Stated differently, a blade sub-edge (exemplifying with the first sub-edge 110) could comprise a first mechanical interlocking structure only extending between the first insert pocket and a sub-edge center 146 (i.e. in a half of a sub-edge closer to the insert pocket). The first mechanical interlocking structure could extend only within a third of the sub-edge length LS from the first insert pocket.

Notably, the first blade mechanical interlocking structure is not provided at the relief side, which is planar (i.e. straight in a side view as shown in FIG. 2A). This is to allow suitable relief for the parting-blade relative to the typically cylindrical (or like shaped) workpiece.

Thus the first blade mechanical interlocking structure extends along a majority of the first sub-edge 110 (i.e. excluding the first and second blade safety recesses and the relief side).

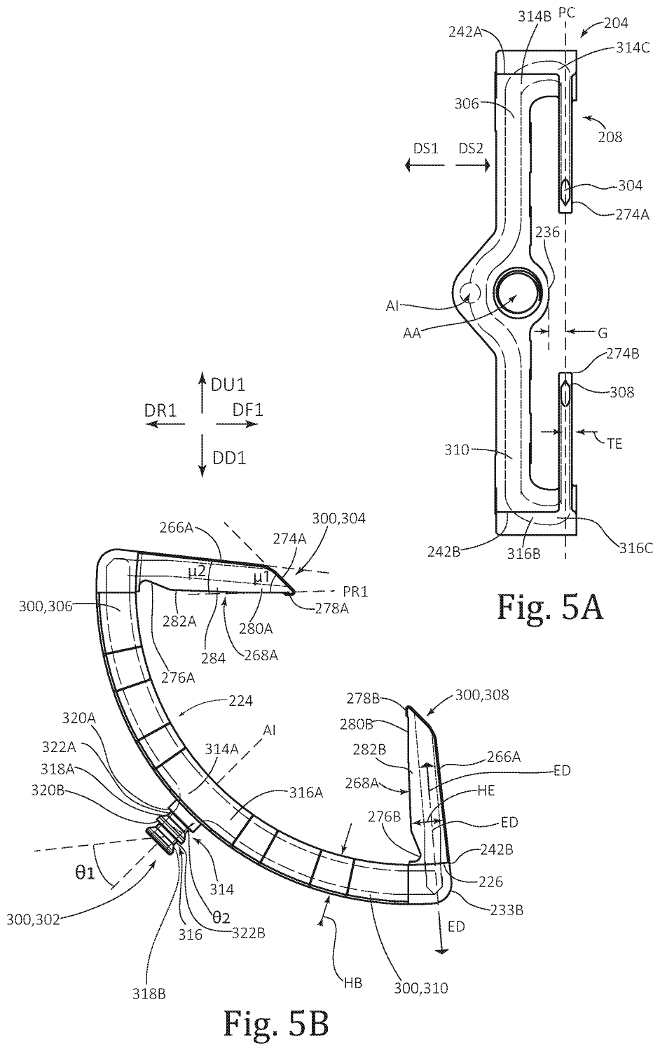

Regarding the position of the first blade safety recess 132B of the second blade sub-edge 112 (which is closest to oncoming chips), to ensure a safe distance from oncoming chips a front extension surface 274A (FIG. 5B) it is preferred the extension portion (or “arm”) be somewhat distanced from the cutting insert, yet close enough to provide effective coolant (with increasing proximity there is greater effectiveness). Since the first blade safety recess 132B position is associated with a forwardmost point of the front extension surface 274A, the position of the first blade safety recess 132B also relates, or defines, the position of the front extension surface 274A. Thus a recess length LR is measured from the associated sub-edge (in FIG. 2A exemplified for the fourth blade sub-edge 116 as the distance from the third pocket's 122 second jaw to an adjacent blade safety recess 116A).

More precisely, while the second blade mechanical interlocking structure 130 is considered to extend along the entire second sub-edge 112 (i.e. the majority thereof excluding small interruptions as discussed below), theoretically, the second blade mechanical interlocking structure 130 can be considered to comprises three sub-structures, a first sub-structure 140B proximate to the first insert pocket 118, a second sub-structure 142B adjacent to the second insert pocket 120, and a third sub-structure 144B located between the first and second sub-structures 140B, 142B. It is understood that the designations “first” and “third”, as applied to the blade mechanical interlocking sub-structures are interchangeable, depending on which of the insert pockets is considered operative.

To provide for a preferred, yet optional, symmetric clamp, the blade safety recesses are preferably equally distanced from an insert pocket. More precisely, extension lines E1, E2 from adjacent blade sub-edges can meet at an extension line intersection E3, defining equal safety recess distances DSR1, DSR2. [E2—need to clarify from where]

Referring to FIGS. 2D to 2F, an explanation of the term “mechanical interlocking structure” (which similarly applies to both blade mechanical locking structures and clamp or extension mechanical locking structures of the present invention) will be elaborated with schematic examples.

A mechanical interlocking structure (hereinafter “interlocking structure” or “mechanical structure” or “structure” for conciseness) can be any mechanical structure, excluding friction alone, which can obstruct a lateral force applied to either of the components comprising the structure.

In FIG. 2D, a first (mechanical) interlocking structure comprising first and second interlocking structures 148, 150 is shown. The first interlocking structure 148 corresponds to the first blade mechanical interlocking structure 128 exemplified and described above.

A second interlocking structure 150 is shown above the first interlocking structure 148 and is configured for mating therewith (i.e. complementary). The second interlocking structure 150 corresponds to the extension mechanical interlocking structure 280A of the first extension portion 208, exemplified and described below.

To reiterate, the first interlocking structure 148 comprises a central apex 128A and first and second blade sub-edge abutment surfaces 128B, 128C extending from the apex, at an internal blade angle α, to the first and second blade sides 102, 104.

The second interlocking structure 150 comprises a central nadir 290A and first and second extension sub-edge abutment surfaces 292A, 294A extending from the nadir 290A.

It will be understood that while the first and second blade sub-edge abutment surfaces 128B, 128C and the first and second extension sub-edge abutment surfaces 292A, 294A are preferably planar, they could also be curved. For example, the first and second extension sub-edge abutment surfaces 292A, 294A could be convexly curved and the first and second blade sub-edge abutment surfaces 128B, 128C could be planar, or any other combination.

When the first interlocking structure 148 is biased against the second interlocking structure 150, lateral movement in the blade first and second sideward directions DS1B, DS2B (the directions used have been made in reference to the parting-blade but could be equally applicable to the clamp directions defined below) is impeded by not only friction but a mechanical obstruction (i.e. two projections obstructing each other).

To elaborate, the first blade sub-edge abutment surface 128B abuts the first extension sub-edge abutment surface 292A, and the second blade sub-edge abutment surface 128C abuts the second extension sub-edge abutment surface 294A. Preferably the apex 128A and central nadir 290A are configured to be spaced apart from each other so that they do not contact (i.e. a gap being left therebetween) to ensure abutment of said abutment surfaces.

If a sideways force is applied on the first interlocking structure 148 in the blade second sideward direction DS2B, said biasing of the first blade sub-edge abutment surface 128B against the first extension sub-edge abutment surface 292A (i.e. two mechanical or geometric projections engaging each other) obstructs relative movement of the first interlocking structure 148 to, or disengagement from, the second interlocking structure 150.

Similarly, if a sideways force is applied on the second interlocking structure 150 in the blade first sideward direction DS1B, the biasing of the first blade sub-edge abutment surface 128B against the first extension sub-edge abutment surface 292A obstructs relative movement or disengagement of the first interlocking structure 148 and the second interlocking structure 150.

Similarly, if a sideways force is applied on the first interlocking structure 148 in the blade first sideward direction DS1B, said biasing of the second blade sub-edge abutment surface 128C against the second extension sub-edge abutment surface 294A obstructs relative movement or disengagement of the first interlocking structure 148 and the second interlocking structure 150.

Similarly, if a sideways force is applied on the second interlocking structure 150 in the blade second sideward direction DS2B, said biasing of the second blade sub-edge abutment surface 128C against the second extension sub-edge abutment surface 294A obstructs relative movement or disengagement of the first interlocking structure 148 and the second interlocking structure 150.

A third interlocking structure 152 with a mechanical interlocking structure is shown. The third interlocking structure 152, or more precisely the abutment surface 256A thereof, corresponds to the first clamp abutment surface 256A exemplified and described below.

When the third interlocking structure 152 is biased against the first interlocking structure 148, the only abutment is between the first clamp abutment surface 256A and the second blade sub-edge abutment surface 128C.

From the third interlocking structure 152, it will first be appreciated that interlocking structures do not need to have only mirror image structures.

In the example given this is sufficient, since there is only mechanical obstruction in one side direction (which is sufficient for the embodiment below since the holder 12 provides a mechanical obstruction to the parting-blade 100 in the other direction).

It will be understood that a blade mechanical interlocking structure is a safety feature introduced to prevent lateral movement of the clamp abutment surfaces which abut the parting-blade. To elaborate, it is feasible that a parting-blade or clamp according to the present invention can be devoid of a mechanical interlocking structure.

For example, in FIG. 2E there is shown: a fourth interlocking structure 156 comprising parallel first and second sidewalls 156A, 156B and an abutment surface 156C perpendicular to the first and second sidewalls 156A, 156B; and a fifth interlocking structure 158 comprising parallel first and second sidewalls 158A, 158B and an abutment surface 158C perpendicular to the first and second sidewalls 158A, 158B.

When the abutment surfaces 156C, 158C are biased against each other there will not be any mechanical obstruction (or geometric projection) to prevent relative movement if side forces are applied to them. This is because both the abutment surfaces 156C, 158C shown are planar and parallel to each other.

However, if they are biased with significant force against each other there may be sufficient frictional force to maintain the abutment surfaces in contact and in a desired position, against a certain amount of side forces.

Additionally, even the very act of biasing two abutment surfaces against each other is a safety feature. If the structure which provides coolant is rigid enough, there may be some conditions where it may be able to withstand vibration and impact of chips. For example, providing an elongated structure in the upward and downward directions DUB, DDB will be considerably more rigid than the circular tube conduits of the prior art (having a diameter of the same width in a direction perpendicular to the upward and downward directions DUB, DDB).

Notwithstanding the above-said, it is of course preferred that the embodiments of the present invention include the first safety feature (of biasing the abutment surfaces against each other). Additionally, it is even further, strongly, preferred that mechanical interlocking structures be provided.

For example, apart from being more able to withstand side forces, another advantage of the safety feature of the mechanical interlocking structure is that if there is a slight bend in either of the structures, the biasing of the two opposing structures against each other may correct the misalignment of the structures.

However, it was discovered during development that overly strong biasing creates a risk of unintentionally bending a (typically very thin) parting-blade (especially if one of the components is bent or tilted when mounted). Hence an overly strong biasing for a mechanical interlocking structure is also a risk.

Regardless of whether there is biasing or a mechanical interlocking structure, it is preferred that a parting-blade always be thinner than a parting-blade (or portion thereof) configured to remain within the same extended-width cutting plane PC thereof. As explained below, in this context, an “extended-width cutting plane PC” is defined to have the same width as the cutting edge width CW of a cutting insert used in parting or grooving.

Still referring to FIG. 2E, as an example, assuming that the fourth interlocking structure 156 is a parting-blade and the upper structure is an extension portion, it is generally preferred that the extension portion have a maximum extension thickness 1E which is smaller than a blade's thickness dimension DT.

This is applicable for all of the biasing and mechanical interlocking structures exemplified and is yet another preferred yet optional safety feature. It will be understood that such safety feature mitigates a risk of non-perfect mounting, i.e. it can compensate for tilting of the extension portion causing it to extend outside of an extended-width cutting plane PC—a cutting “plane” having a width corresponding to an insert cut width CW (“extended-width cutting plane”). It will be understood that production and aligned mounting of components having less than 4 mm width, 3 mm width and even less than 2 mm, is a significant task.

Reverting to the general discussion of mechanical structure options. It should be understood that the blade mechanical interlocking structure can be various other structures.

In FIG. 2F there are shown sixth, seventh and eighth interlocking structures 160, 162, 164, which could equally be a mechanical interlocking structure of a parting-blade (or clamp or extension portion). It will be understood that a parting-blade preferably has a male structure such as those shown in the first and third structures 148, 152, since they are easier to produce on parting-blades, but female structures on a parting-blades are also feasible.

The sixth interlocking structure 160 comprises parallel first and second sub-edge surfaces 160A, 160B separated by a sub-edge recess surface 160C located therebetween and in turn comprising a planar recessed surface 160D.

The seventh interlocking structure 162 comprises a single concavely-curved surface 162A. The eighth interlocking structure 164 comprises two angled (v-shaped) sub-edge surfaces 164A, 164B, similar to that shown in the second interlocking structure 150.

A different way to describe the mechanical interlocking structures is via their projections. It will also be noted that the number of projections (i.e. projecting in a direction perpendicular to a thickness dimension) there is at least one blade sub-edge projection and their position is also variable.

For example, the first interlocking structure 148 has a central, sub-edge projection 170A (constituted by the first and second blade sub-edge abutment surfaces 128B, 128C).

Alternatively, the third interlocking structure 152 could be considered to have a single non-central (or side) sub-edge projection 170B.

Alternatively, the second interlocking structure 150 could be considered to have two laterally located sub-edge projections 150A, 150B.

Similarly, the other female structures (i.e. the sixth, seventh and eighth structures 160, 162, 164) can also be considered to have two laterally located sub-edge projections 170C1, 170C2, 170D1, 170D2, 170E1, 170E2.

While a mechanical interlocking structures preferably has a uniform cross section for ease of production, it is also possible to have, as shown in FIG. 2G, a ninth interlocking structure 166 comprising a first projection 166A at one side and then after some distance a second projection 166B at the other side. This similarly can provide lateral support in both sideward directions. Notably, a tenth interlocking structure 148A configured to interlock with the ninth interlocking structure 166 can have a similar non-uniform cross-section. Alternatively, the tenth interlocking structure 148A could instead have a single, uniform, interlocking structure identical to the first interlocking structure 148, even though the cross section of the ninth interlocking structure 166 alternates in cross-section (at least once).

In FIG. 2H, an eleventh interlocking structure 168, shows that even more than two projections (i.e. first, second and third projections 168A, 168B, 168C) is also possible.

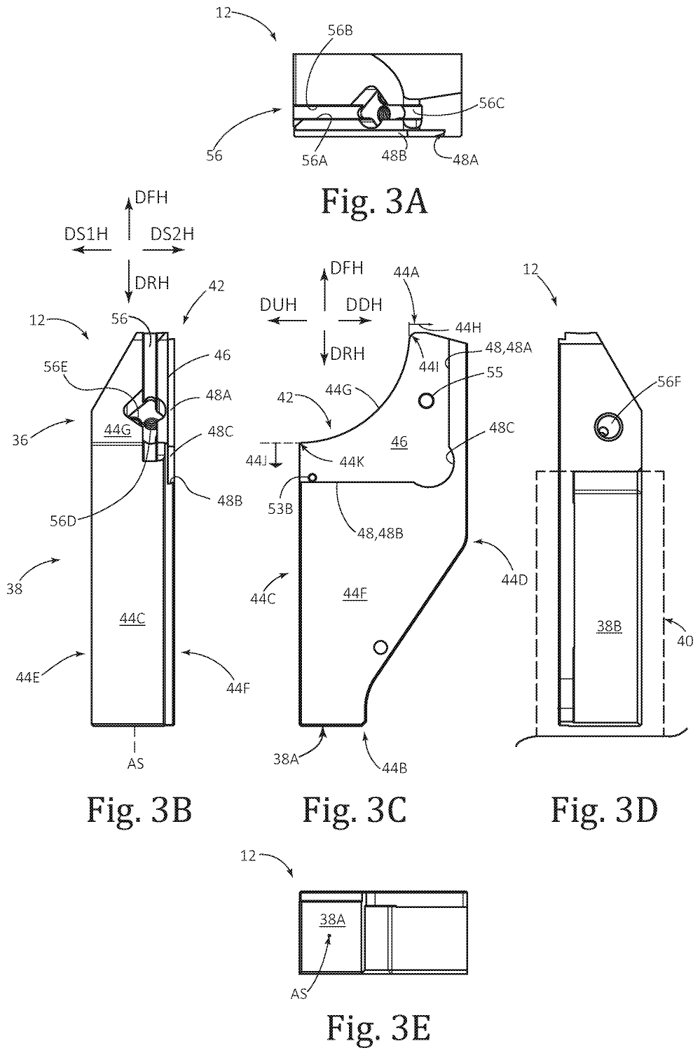

Referring to FIGS. 1B, and 3A to 3E, the blade holder 12 will be described in more detail.

The holder 12 has a basic shape which is generally similar to the holder shown in FIGS. 19 and 20 of USPA 2019/0240741, the contents of which are incorporated herein by reference, with main differences described below.

Shown is a holder forward direction DFH, a holder rearward direction DRH, a holder upward direction DUH, a holder downward direction DDH, a holder first sideward direction DS1H and a holder second sideward direction DS2H.

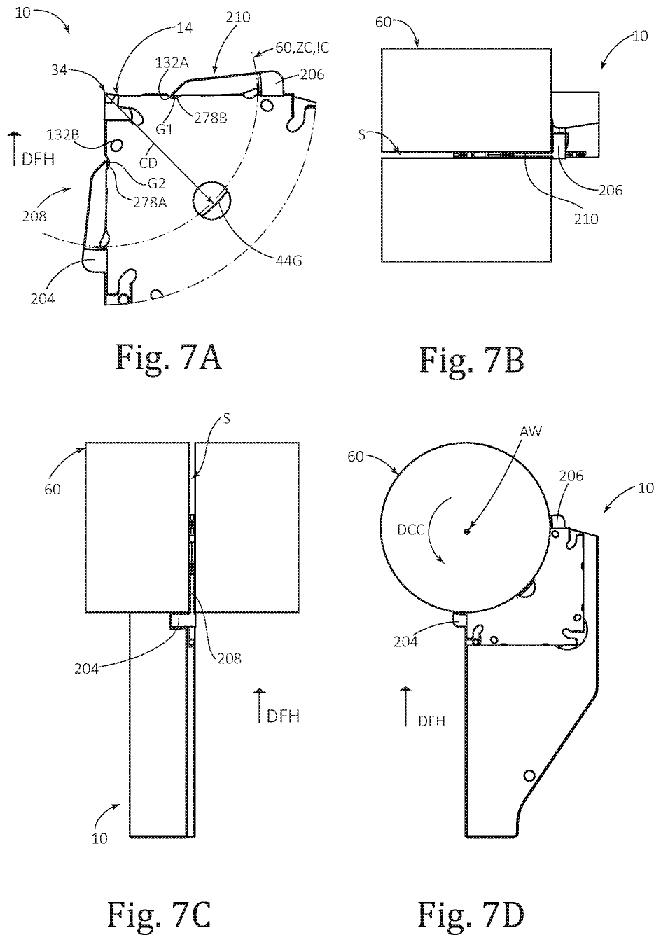

The holder forward direction DFH constitutes an X-axis feed direction in which direction the tool assembly 10 is moved to machine a workpiece 60 shown below (e.g. FIG. 7D).

The holder 12 comprises a holder head portion 36 and a holder shank portion 38.

The holder shank portion 38 is secured to a machine interface 40 which can be a tool post or turret, etc.

The holder head portion 36 comprises a blade-pocket 42.

The holder head portion 36 comprises a holder front surface 44A, a holder rear surface 44B, a holder upper surface 44C, a holder bottom surface 44D, a holder first side surface 44E, a holder second side surface 44F.

Preferably the holder front surface 44A can comprise a front-surface portion 44G which is preferably concavely-shaped.

It will be understood that a first cutting zone boundary 44H is defined in the holder downward direction DDH from a forwardmost point 441 of the front-surface portion 44G, and a second cutting zone boundary 44J is defined in the holder rearward direction DRH from an uppermost point 44K of the front-surface portion 44G.

Stated differently, the holder 12 is designed with a cutting zone ZC (FIG. 7A) which is upward of the first cutting zone boundary 44H and forward of the second cutting zone boundary 44J. Since the workpiece 60 is designed to enter said cutting zone ZC, the holder 12 and assembly 10 cannot have any portions projecting therein which are wider than the cut width CW of the cutting insert 14 or outside of the extended-width cutting plane PC since those portions will impact the workpiece 60 being parted. The arrows of the first cutting zone boundary 44H and second cutting zone boundary 44J show the area that a workpiece cannot pass, since it would collide with the holder 12 which is wider than the extended-width cutting plane PC

Conversely, outside of the defined cutting zone ZC the assembly, holder, clamp etc. can project outside of the extended-width cutting plane PC.

Alternatively, it will be understood that all tool assemblies are designed for a given depth of cut CD. Thus, the cutting zone is an imaginary cylinder IC (FIG. 7A) which corresponds in shape to the workpiece 60 shown, the imaginary cylinder IC being defined by a radius equal in length to the depth of cut CD (which in turn is defined from from the front-surface portion 44G to the forwardmost cutting edge 34 of the cutting insert 14). It will be understood that the actual workpiece diameter must be slightly smaller than the depth of cut CD to provide a tolerance (e.g. 1 mm). Outside of the imaginary cylinder IC, the clamp 200 can extend in any direction and not be impacted by the workpiece 60 during parting thereof.

Stated differently, the holder 12 is designed for parting a cylindrical workpiece 60 having a radius corresponding to the cut depth CD shown in FIG. 7A (i.e. from the front-surface portion 44G to the forwardmost cutting edge 34 of the cutting insert 14), or more precisely slightly smaller than that (e.g. providing one or two millimeters relief). And as seen in from FIGS. 7A and 7C, parts of first clamp portion 204 and second clamp portion 206 which are outside the imaginary cylinder IC, can be configured to not enter the slit S formed in the cylindrical work piece. On the other hand, parts of the extension portions 208, 210 must be configured (e.g., narrow enough) to enter the S.

The blade-pocket 42 comprises a blade-pocket side surface 46, and a pocket projecting edge 48 extending therealong.

The pocket projecting edge 48 can comprise a pocket lower abutment surface 48A, and a pocket rear abutment surface 48B and preferably a pocket relief recess 48C.

To provide lateral securing forces, the pocket projecting edge 48 is formed with a slanted (or oblique) mechanical interlocking structure. To elaborate the pocket lower abutment surface 48A and the pocket rear abutment surface 48B both are slanted with a construction corresponding to the third interlocking structure 152. This allows less lateral projection of the holder 12 in the holder second sideward direction DS2H than is the case where a screw or seal is present (see FIG. 20E of USPA 2019/0240741).

The slant of the pocket lower abutment surface 48A is visible in FIG. 3A, and the slant of the pocket rear abutment surface 48B is visible in FIG. 3B.

In this example, the slanted pocket projecting edge 48 biases the parting-blade 100 toward the blade-pocket side surface 46 for strong constructional strength.

Preferably, the blade-pocket side surface 46 extends adjacent to the entire parting-blade to provide bending of the parting-blade 100 when (for example referring to the first clamp portion 204) the first clamp abutment surface 256A abuts the parting-blade's second blade sub-edge abutment surface 128C. Due to the thin parting-blade construction, it is particularly susceptible to bending which could prevent the parting-blade from being able to make a straight cut in a workpiece.

The holder shank portion 38 may have a terminal end portion that has a cylindrical, or square cross-section. In FIG. 3B, the holder shank portion 38 is seen to have a holder shank axis As, which is shown for understanding of the position thereof had the holder shank cross-sectional shape have been round.

The blade-pocket 42, and more particularly the blade-pocket side surface 46, is formed with a pin hole 53B for holding a pocket projection, which in this non-limiting example is the pin 22 shown in FIG. 1B. The pin 22 prevents the parting-blade 100 from being accidentally inserted in a y-axis feed direction (i.e. the holder upward direction DUH) when the operator desires that an x-axis feed direction be used. To operate in a y-axis feed direction, the pin 22 is removed from the pin hole 53B. It will be understood that the pin hole's position could be changed to make the y-axis feed direction the default for when a pin is inserted.

The blade-pocket 42, and more particularly the blade-pocket side surface 46, is formed with a magnet hole 55 for holding the magnet 24 shown in FIG. 1B.

The magnet 24 prevents the parting-blade 100 from falling from the holder 12 when the clamp 200 is not securing the parting-blade 100 to the holder 12.

Thus this is an additional, preferred but non-essential, feature added for user-friendliness. The magnet 24 is not capable of securing the parting-blade against clamping forces and hence is only to prevent so-called “falling parts”. Such magnet 24 provides an auxiliary attachment mechanism which obviates the need for any corresponding construction on the parting-blade (particularly useful for extremely thin blades with little room for mechanical connections, and for indexable parting-blades which would otherwise require corresponding constructions for each index of the parting-blade). It is also noted that such auxiliary attachment mechanism does not create an obstruction to slidably mounting the parting-blade 100 into the slanted pocket projecting edges 48.

While magnets are known to be used in conjunction with cutting tools, it is not hitherto known to use an embedded magnet in either a cutting insert pocket or a parting-blade pocket. This is because magnets are not sufficiently strong to hold cutting inserts or parting-blades against machining forces.

Stated differently, the present invention provides as a completely separate aspect an insert or adaptor (or parting-blade) pocket with an auxiliary attachment mechanism in the form of a magnet secured to the pocket. Such a construction also includes a clamp or screw or other securing mechanism for providing a main attachment mechanism.

A second reason such construction is not known is because it has long been believed that an embedded magnet can magnetise the holder (due to long-term contact of the magnet and holder) causing chips to undesirably connect to the holder or jam in between components.

It was found after production, that such magnetization of the holder 12 was of insufficient strength to cause an effect during machining.

The magnet 24, when mounted to the magnet hole 55, is preferably either flush with the blade-pocket side surface 46 or recessed therein so as to not interfere with abutment of the parting-blade against the blade-pocket side surface 46.

Preferably, the parting-blade 100 completely covers the magnet 24 so that chips (not shown) are not attracted thereto.

While the surrounding walls of the magnet hole 55, in theory, resist the parting-blade from pulling the magnet 24, as a safety precaution, the magnet 24 can be glued to the magnet hole 55.

The holder front surface 44 is formed with a groove 56.

The groove 56 is shaped to receive the clamp 200 and more particularly the majority of the clamp's body portion 202 therein.

Preferably the groove opens out at a front side thereof to a front end of the holder 12. Preferably the groove opens out at a rear side thereof to a top end of the holder. This allows the clamp to be held therein to only project from the groove at areas outside of a cutting zone ZC as will be shown below.

The groove 56 comprises first and second sidewalls 56A, 56B and a groove bottom wall 56C.

The depth of the groove 56 is sized to allow the clamp's body portion 202 when mounted therein and securing the parting-blade 100, to be either flush with the holder front surface 44 or receded therein so as to not interfere with passage of the workpiece.

More precisely, the groove 56 has a depth from the front-surface portion 44G which is greater than a body height HB (FIG. 5B) of the body portion 202 defined between the upper (or “inner”) body surface 226 and the lower (or “outer”) body surface 228.

The holder 12 further comprises, or in this example is formed with, a holder attachment portion 56D. In this example the holder attachment portion is a threaded holder screw-hole 56D formed in the groove bottom wall 56C.

The groove 56 further comprises a holder outlet 56E configured to provide coolant to, and in this example receive therein, the clamp's inlet 302.

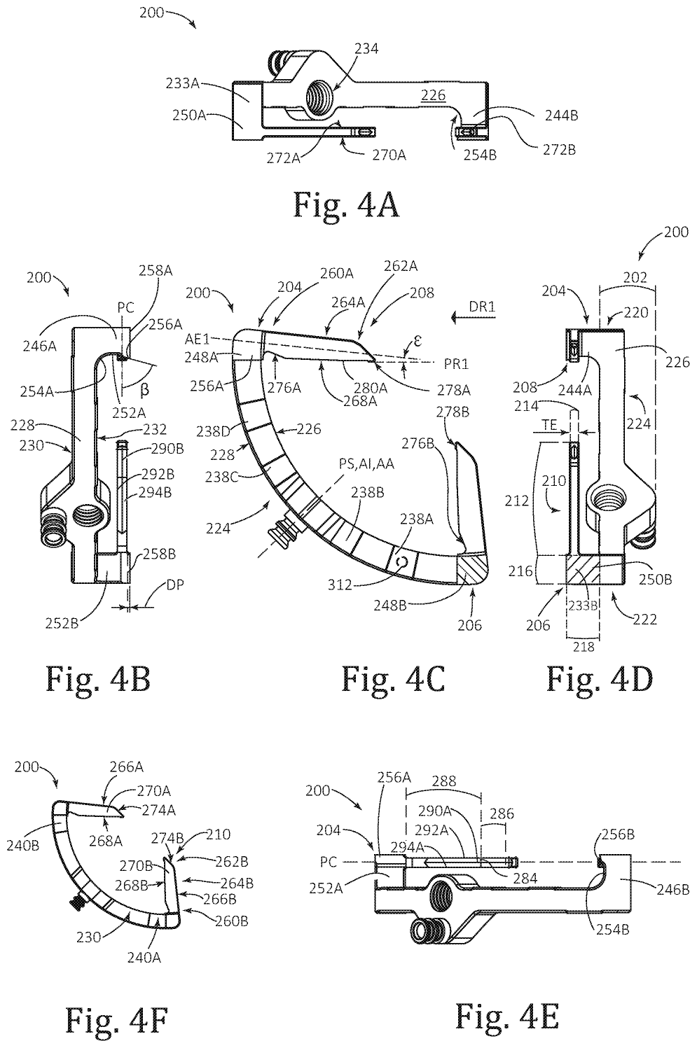

As noted above, at least one holder outlet 56E could have alternatively been formed in, for example, the first sidewall 56A to provide coolant to the clamp aperture 312 shown in FIG. 4C.

Coolant is provided to the holder 12 via a holder inlet 56F located on the holder bottom surface 44D. However, it will be understood that the holder inlet 56F could be located, for example, at a shank rear surface 38A or shank bottom surface 38B, or there could be multiple holder inlets at any combination of these positions. Although not shown, it is preferable that there be holder inlets at each of these three positions to maximize options to provide coolant to the clamp 200 for different machine interfaces. One or more plugs can be provided and fitted to the holder inlets which are not in use. Although no plug is necessary for a holder inlet located along the shank bottom surface 38B since the machine interface clamping that surface will seal the hole, thereby reducing the number of pieces of the assembly 10. Nonetheless, for hermetic sealing a plug could be provided or an o-ring extended therearound.

Referring to FIGS. 4A to 5B, the parting-blade clamp 200 will be described in more detail.

The parting-blade clamp 200 comprises a body portion 202, a first clamp portion 204 extending from the body portion 202, a second clamp portion 206 extending from the body portion 202, a first extension portion 208 (or “first arm”) extending from the first clamp portion 204, and a second extension portion 210 (or “second arm”) extending from the second clamp portion 206.

The present example is symmetrical about a symmetry plane PS (FIG. 4C) extending through the center of the body portion 202. Therefore, each feature described in relation to the first clamp portion 204 also applies to the second clamp portion 206, similarly each feature described in relation to the first extension portion 208 also applies to the second extension portion 210.

Merely for the purposes of explaining the boundaries of what is meant by said first and second clamp portions 204, 206, schematic hatching has been added to FIGS. 4C and 4D to identify what is meant by the name “second clamp portion 206” (which was arbitrarily chosen out of the two identical clamp portions).

To elaborate, referring to FIG. 4D, the second extension portion 210 is defined within the areas shown by the reference numerals 212 and 214; the second clamp portion 206 is defined within the areas shown by the reference numerals 216 and 218; and the body portion 202 is the remainder of the parting-blade clamp 200 except for the first clamp portion 204 and the first extension portion 208.

The body portion 202 will now be described in detail.

The body portion 202 comprises a first body end 220, a second body end 222 and an intermediary sub-portion 224 connecting the first body end 220 and the second body end 222.

The intermediary sub-portion 224 further comprises: an upper (or “inner”) body surface 226, a lower (or “outer”) body surface 228 located opposite the upper body surface 226; a first side body surface 230 connecting the upper body surface 226 and the lower body surface 228; a second side body surface 232 connecting the upper body surface 226 and the lower body surface 228; a first end body surface 233A and a second end body surface 233B.

The intermediary sub-portion 224 further comprises an attachment portion 234. The attachment portion 234 can be any construction configured to secure the parting-blade 100 to the holder 12. Thus the “attachment portion” could also be called a “holder attachment portion”. For example, the attachment portion can be a female thread (shown) or any known construction (e.g. having projection(s) to receive a lever, a hook or hook receiving configuration, a recess to be abutted by a screw head that extends alongside and not through the intermediary sub-portion 224).

In this preferred embodiment the attachment portion 234 is a female thread having an attachment axis AA (FIG. 5A) extending through the center thereof, allowing for the standard double-threaded screw 16 to be used. Advantageously, the screw 16 is a right-hand and left-hand screw which allows the screw 16 to lift the parting-blade clamp 200 out of the holder 12 (allowing swift removal of the parting-blade 100) without the need for extra components such as springs, etc. More particularly, while standard threads are typically right-handed, the female thread 234 is a left-handed thread for the above-mentioned purpose.

Drawing attention to FIGS. 5A and 5B, in the non-limiting embodiment, the parting-blade clamp 200 further comprises a coolant passageway 300.

The coolant passageway 300 comprises an inlet 302, a first outlet 304, a first intermediary passageway 306 extending from the inlet 302 to the first outlet 304, a second outlet 308, a second intermediary passageway 310 extending from the inlet 302 to the second outlet 308.

In the present example the inlet 302 is formed at the intermediary sub-portion 224.

In this preferred embodiment the inlet 302 is a male-projection 302 having an inlet axis AI (FIG. 5A) extending through the center thereof. It will be understood that an inlet could be provided in different ways. For example, an aperture 312 (without any projection; shown schematically in dashed lines in FIG. 4C) can be formed in one of the first and second side body surfaces 230, 232 (exemplified in the second side body surface 232) at a location which abuts the holder 12 when the parting-blade clamp 200 is mounted thereto (such abutment reducing leakage).

In the present embodiment, since a projection is utilized, it is preferred that the attachment axis AA and the inlet axis AI extend parallel to each other to allow ease of insertion of both into the holder 12.

Referring to FIG. 5B, to prevent leakage, the exemplified male projection 302 is formed with identical first and second o-ring recesses 314, 316 each configured to receive one of the first and second o-rings 18, 20. While a single o-ring recess and a single o-ring is also feasible, since a larger coolant supply is advantageous, and coolant supply can be increased by utilizing high pressure coolant, a second o-ring recess and second o-ring were provided to ensure ultra-high coolant pressure (e.g. 340 bar or higher) with minimal or no leakage.

Since the parting-blade clamp 200 exemplified was produced with additive manufacturing (3D printing), it was found advantageous to provide the first and second o-ring recesses 314, 316 with a unique construction. More precisely, each of the first and second o-ring recesses 314, 316 comprises a first (lower) annular ring 318A, 318B, a second (upper) annular ring 320A, 320B and a ring recess 322A, 322B therebetween.

As shown each first annular ring 318A, 318B is slanted towards the associated ring recess 322A, 322B at a first ring angle θ1 formed with the inlet axis AI fulfilling the condition: θ1≤45°, preferably θ1≤43°. Whereas each opposing second annular ring 320A, 320B is oriented relative to the associated ring recess 322A, 322B at a second ring angle θ2 formed with the inlet axis AI fulfilling the condition: θ2≤90°. These constructions were provided for a printing orientation where the male projection 302 is the highest vertical portion of the parting-blade clamp 200. It will be understood that the constructions of the first annular rings 318A, 318B and the second annular rings 320A, 320B could be reversed, for an opposite printing orientation. It will also be understood that the construction of the exemplified second annular rings 320A, 320B could be other than the right-angle shown.

Preferably the attachment portion 234 is closer to the first and second clamp portions 204, 206 than the inlet 302. This reduces tilting of the parting-blade clamp 200 when being mounted to, or when mounted on, the parting-blade 100. While this results in a coolant passageway 300 requiring an extra turn (which is disadvantageous for maintaining coolant pressure) to circumvent the attachment portion 234, it is believed that reducing said tilt is preferred.

While it would be preferred that the attachment portion 234 intersect an extended-width cutting plane PC defined along the surfaces (to be described hereinafter) configured to abut the parting-blade 100 lie, in the present non-limiting example a gap G (FIG. 5A) is provided between a closest point 236 of the body portion 202 (which in this example is the attachment portion 234) and the center of the extended-width cutting plane PC, to allow additional support of the parting-blade along a blade-pocket side surface 46. Nonetheless, it will be understood that such pocket support wall could be provided with a window and the attachment portion 234 could extend therethrough. Similarly, it will be understood that it is still feasible to provide a parting-blade clamp according to the present invention with the inlet closer to one of the clamp portions 204, 206 than to the attachment portion 234.

Yet another feature incorporated to reduce said risk of tilt, is the provision of a plurality of outwardly projecting clamp abutment surfaces (in this example, as shown in FIG. 4C, first, second, third, and fourth clamp abutment surfaces 238A, 238B, 238C, 238D formed along the second side body surface 232 and, as shown in FIG. 4F, fifth and sixth clamp abutment surfaces 240A, 240B formed along the first side body surface 230). Similar to that stated above, it is still feasible to provide a parting-blade clamp according to the present invention with planar first and second body surfaces.

Subsequent to extensive testing, it was found preferable that each of first body edge ends 242A, 242B (for example the second body edge end 242B extends along an intersection of the upper body surface 226 and the second end body surface 233B) not be a sharp angle (approximately a right angle) as shown, but rather be convexly-curved (not shown), to reduce chipping from impact with a falling parted-off piece (not shown) during machining.

The first clamp portion 204 will now be described in detail. Since the first and second clamp portions 204, 206 are identical, less detail may be used to describe the second clamp portion 206.

The first clamp portion 204 extends from the first body end 220. More precisely, while the body portion 202 extends parallel to the extended-width cutting plane PC, the first clamp portion 204 extends laterally from the first body end 220 (or more precisely from the parallel extension thereof relative to the extended-width cutting plane PC). In this non-limiting example, the clamp portion 204 extends orthogonally therefrom. Regardless of the exact angle, importantly, a clamp abutment surface (describe below) of the first clamp portion 204 lies in the extended-width cutting plane PC.

The first clamp portion 204 comprises a first upper clamp surface 244A (connected to the upper body surface 226), a first lower clamp surface 246A located opposite the first upper clamp surface 244A (connected to the lower body surface 228); a first side clamp surface 248A connecting the first upper clamp surface 244A and the first lower clamp surface 246A, a first outer clamp surface 250A (connected to the first end body surface 233A) and a first inner clamp surface 252A (connected to the second side body surface 232 via a large first radiused corner 254A provided to withstand clamping stresses).

The first inner clamp surface 252A comprises a first clamp abutment surface 256A.

The second clamp portion 206 comprises a second upper clamp surface 244B, a second lower clamp surface 246B, a second side clamp surface 248B, a second outer clamp surface 250B and a second inner clamp surface 252B (connected to the first side body surface 232 via a large second radiused corner 254B provided to withstand clamping stresses).

The second inner clamp surface 252B comprises a second clamp abutment surface 256B.

Both of the first and second clamp abutment surfaces 256A, 256B, at least partially, lie on the extended-width cutting plane PC (FIG. 4E). Preferably both are elongated along the extended-width cutting plane PC to provide additional strength when clamping the parting-blade 100.

It will be noted that the first and second clamp portions 204, 206, as well as the body portion 202 they are connected too, are significantly larger (bulkier) than the thin elongated first and second extension portions 208, 210. This is because the first and second clamp portions 204, 206 are configured to provide a clamping function to the parting-blade, applying a clamping force on the order of hundreds of kilograms of force, and not essentially designed to provide a strong abutment between two elements as will be discussed below in connection to the first and second extension portions 208, 210.

To provide additional strength, the first and second clamp portions 204, 206 comprise first and second projection portions 258A, 258B which extend past the first and second extension portions 208, 210 by a projection distance DP.

While the first and second clamp abutment surfaces 256A, 256B could extend orthogonal to the extended-width cutting plane PC to merely apply backward or rearward force on the parting-blade 100, in the present embodiment it is preferred that they be slanted at an acute angle (FIG. 4B) to bias the parting-blade 100 against a holder pocket (described below). Stated differently, the first and second clamp abutment surfaces 256A, 256B are slanted towards the first side body surface 232.

This obviates the need for a screw or plurality of screws to provide a lateral clamping force. However, as mentioned above, there may be circumstances where one or more screws can be used in conjunction with such clamp abutment surface(s).

As shown, in the present example each of the first and second clamp abutment surfaces 256A, 256B are a single slanted surface.

Each of the first and second extension portions 208, 210 comprises a first (proximal) extension end 260A, 260B (connected to the body portion 202), a second (distal) extension end 262A, 262B (further from the body portion 202 than the associated distal extension end of the same extension portion), an elongated intermediary extension sub-portion 264A, 264B, an upper (outer) extension surface 266A, 266B, a lower (inner) extension surface 268A, 268B located opposite the upper extension surface 266A, 266B, a first side extension surface 270A, 270B connecting the upper extension surface 266A, 266B, and the lower extension surface 266A, 266B, a second side extension surface 272A, 272B connecting the upper extension surface 266A, 266B, and the lower extension surface 266A, 266B, a front extension surface 274A, 274B located at the second extension end 262A, 262B and connecting the upper, lower, first side and second side extension surfaces 266A, 266B, 268A, 268B, 270A, 270B, 272A, 272B.

Elements of the first extension portion 208 will now be described in detail. Since the first and second extension portions 208, 210 are identical, less detail may be used to describe the second extension portion 210.

The first extension end 260A is connected to the first clamp portion 204 and more precisely to the first upper clamp surface 244A. It will be understood that an extension portion does not need to be associated with a clamp portion (for example there may be a single clamp portion and two extension portions), and in such case an extension portion (not shown) can be directly connected to a body portion.

The lower extension surface 268A comprises at the first extension end 260A an elasticity recess 276A configured to reduce stresses on the first extension portion 208 when it is biased against the parting-blade. It will be understood that an elasticity recess could be alternatively or additionally formed along the upper extension surface 266A at the first extension end 260A. However, a preferred position is shown.

The lower extension surface 268A further comprises at the second extension end 262A an extension safety projection 278A.

The lower extension surface 268A further comprises at the second extension end 262A a distal extension mechanical interlocking structure 280A which is located closer than the extension safety projection 278A to the first extension end 260A.

The lower extension surface 268A further comprises at the intermediary extension sub-portion 264A a proximal extension mechanical interlocking structure 282A.

Both the extension mechanical interlocking structures 280A, 282A of the lower extension surface 268A comprise a central nadir 290A and first and second extension sub-edge abutment surfaces 292A, 294A extending from the nadir 290A. In some embodiments, by virtue of the central nadir 290A and the adjoining extension sub-edge abutment surfaces 292A, 294A, the extension mechanical interlocking structures 280A, 282A each may have a v-shaped cross-section. In other embodiments, they may exhibit one of the other mechanical interlocking formations seen above in FIGS. 2D-2F.

As best shown in FIG. 5B there is a slight change in angle between the distal extension mechanical interlocking structure 280A at the second extension end 262A and the proximal extension mechanical interlocking structure 282A at the intermediary extension sub-portion 264A. A curvature line denoted 284 in FIG. 4E (and also in FIG. 5B) shows the position of the change of angle.

This is because the intended abutment area (also called “first extension abutment surface”) of the lower extension surface 268A and the parting-blade 100 is only at the second extension end 262A (and in this example the first extension abutment surface is formed with a mechanical interlocking structure, i.e. the distal extension mechanical interlocking structure 280A. The reason for the desire to specifically abut the lower extension surface 268A at the second extension end 262A is, inter alia, a safety measure to ensure that the second extension end 262A is firmly biased against the parting-blade 100 so that no chips will become lodged therebetween. Nonetheless, it is a feasible option to have a planar lower extension surface 268A (i.e., one without a change in angle) which also abuts a parting-blade at the intermediary extension sub-portion thereof.

To elaborate regarding the present example, referring to FIG. 4E, only the area designated 286 is intended to contact the parting-blade 100, with the area designated 288 not being intended to contact the parting-blade 100.

The intermediary extension sub-portion 264A is provided with the proximal extension mechanical interlocking structure 282A to reduce the gap between the parting-blade and the lower extension surface 268A and thereby reduce the likelihood that chips will become lodged therebetween.

For explanatory purposes only, a first reference plane PR1 (FIGS. 4C and 5B) can be defined by the distal extension mechanical interlocking structure 280A at the second extension end 262A. This reference is chosen since it is the abutment area with the parting-blade 100.

As best shown in FIG. 5B, the extension safety projection 278A extends underneath the first reference plane PR1.

The proximal extension mechanical interlocking structure 282A extends above the first reference plane PR1.

Notably, the first clamp abutment surface 256A extends above the first reference plane PR1. This configures the distal extension mechanical interlocking structure 280A to contact the parting-blade 100 before the first clamp abutment surface 256A contacts the parting-blade 100. It will be understood that there is a manufacturing difficulty in providing numerous contact points between two mating components. Since an extension portion 208, 210 of the present invention is by definition less rigid than an associated clamp portion, it has been designed to be slightly flexible. To elaborate, when the clamp 200 is mounted to the parting-blade 100, the screw 16 is rotated bringing the distal extension mechanical interlocking structure 280A to contact the parting-blade 100. Rotation of the screw 16 continues causing the first extension portion 208 to flex (and apply a biasing force on the parting-blade 100) until the first clamp abutment surface 256A subsequently contacts and clamps the parting-blade 100. Said flexing or bending is assisted by weakening a rearmost region of the first extension portion 208 with the elasticity recess 276A.

Referring to FIGS. 5B and 4C, a first forward direction DF1 is defined parallel with the first reference plane PR1 and from the first extension end 260A towards the second extension end 262A.

A first rearward direction DR1 is defined opposite to the first forward direction DF1.

A first upward direction DU1 is defined perpendicular to the first reference plane PR1 and from the lower extension surface towards the upper extension surface.

A first downward direction DD1 is defined opposite to the first upward direction DU1.

A first sideward direction DS1 is defined opposite to a second sideward direction DS2, both directions extending perpendicularly away from the symmetry plane PS.

A first elongation axis AE1 is defined through the center of the first extension portion 208.

The first elongation axis AE1 and the first reference plane PR1 subtend an acute coolant angle ε (FIG. 4C) in the first rearward direction DR1. This is to ensure the coolant is directed towards the cutting insert 14, and preferably towards a cutting edge thereof.

The front extension surface 274A is a slanted deflection surface. To elaborate, the front extension surface 274A and the first reference plane PR1 subtend a first acute deflection angle μ1, and the upper extension surface 266A and the first reference plane PR1 subtend a second acute deflection angle μ2 which is smaller than the first acute deflection angle μ1. It will be understood that since the first extension portion 208 extends well above the cutting insert 14, there is a significant chance it will be impacted by oncoming chips. If the first deflection angle μ1 were greater, i.e. closer to orthogonal to the first reference plane PR1 the first extension portion 208 could be significantly damaged by oncoming chips. If the first deflection angle μ1 were smaller, similar to the second acute deflection angle μ2, the coolant would exit the parting-blade clamp 200 further from the cutting insert 14 and would be less effective. Additionally, a slanted outlet changes the shape/direction of coolant exiting the extension portion. Preferably the first acute deflection angle μ1 fulfills the condition: 25°≤μ1≤65°, more preferably 35°≤μ1≤55°.

If the second acute deflection angle μ2 were larger, the first extension portion 208 would be significantly stronger (since the extension portion would have a more elongated cross section, adding rigidity against bending backwards when impacted by a chip), however this would result in a less compact construction (discussed below in relation to height HE). In the present example where there are two extension portions and the parting-blade clamp 200 is rotationally symmetrical for right and left handed tools, it would also increase the forward projection of the tool assembly and limit the size of a workpiece which can be parted. Preferably the second acute deflection angle μ2 fulfills the condition: 2°≤μ2≤15°, more preferably 4°≤μ2≤10°.

Yet another optional safety feature is to coat the clamp, or at least the extension portion thereof, or at least the second extension end 262A thereof, with a heat resistant or protective coating.

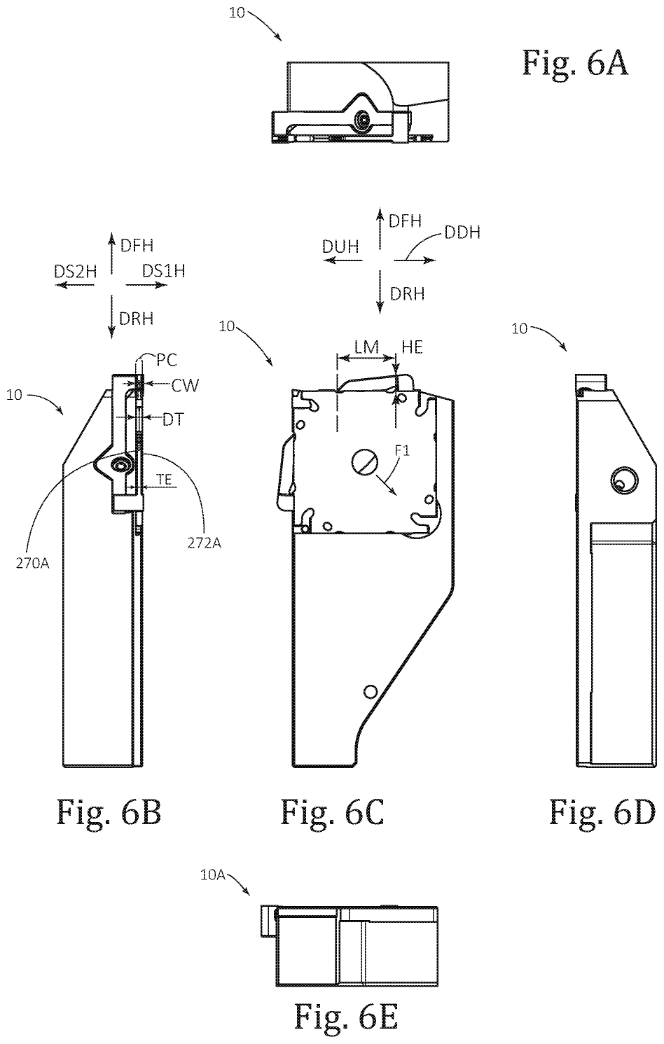

The first and second side extension surfaces 270A, 272A are preferably parallel to one another and extend perpendicular to the first reference plane PR1. This allows a maximum amount of coolant to be conveyed while still maintaining the first extension portion 208 within the extended-width cutting plane PC (i.e. the cutting plane being defined with the same width as the cutting edge width CW of the cutting insert 14; stated differently the extended-width cutting plane is defined by the location of the forwardmost cutting edge 34, has the same width as the cutting edge width CW of the cutting insert 14 and is parallel the feed direction, which is the holder forward direction DFH). It is noted that the extended-width cutting plane consequently extends in all four directions: the holder forward direction DFH, the holder rearward direction DRH the holder upward direction DUH and the holder downward direction DDH. Stated differently, an extension thickness TE (FIG. 6B) defined from the first side extension surface 270A to the second side extension surface 272A is smaller than a cut width CW of the cutting insert 14. This provides relief so that the first extension portion 208 does not impact the workpiece—i.e., does not contact the workpiece as the extension portion 208 enters a groove being cut by the cutting insert. Typically, the blade's thickness dimension DT is always smaller than the cut width CW for the same reason. As a safety precaution, it is preferred that the maximum extension thickness TE is smaller than even the blade's thickness dimension DT to provide relief should undesired tilting during mounting. While this reduces the amount of coolant which can be supplied through the thinner extension portion, the danger of impact is more significant.

Nonetheless, in all embodiments, since the portions of the clamp which are within the cutting zone (and hence within the extended-width cutting plane PC) are by definition very thin in the first and second sideward directions, it is preferred that they be elongated in the upward and downward directions. This can allow structural strength (even in cases where the extension portions are devoid of a coolant passageway) and can increase the coolant passageway cross section (and hence coolant supply) in cases where there is a coolant passageway. However, since there are limiting factors (such as enlarging a symmetric clamp's two extension portions can lead to a decrease in the size of a workpiece that can be machined; increasing the risk of impact by chips; or to merely maintain compactness for exchanging tools in an automatic tool changer) there is a preferred limit to the extent an extension portion can be grown.

Referring to FIGS. 5A and 5B, there is shown a maximum extension portion height HE, defined perpendicular to an elongation direction of the associated extension portion and from the upper extension surface 266A to the lower extension surface 268A, and a maximum extension thickness TE. Preferably these dimensions fulfill the condition: 1.5 TE<HE<8TE, more preferably 2 TE<HE<5TE, and most preferably 2TE<HE<4TE.

For the sake of completeness, some corresponding elements of the identical second extension portion 210 are identified in FIGS. 5B and 4B, namely: an elasticity recess 276B; an extension safety projection 278B; a distal extension mechanical interlocking structure 280B; a proximal extension mechanical interlocking structure 282B; a central nadir 290B; and first and second extension sub-edge abutment surfaces 292B, 294B.

Referring to FIGS. 5A and 5B, the coolant passageway 300 is noted to have a plurality of turns. More precisely, the first intermediary passageway 306 comprises a first turn 314A from the inlet 302 to the intermediary sub-portion 224; a second turn 314B (which is approximately a quarter turn) from the body portion 202 to the first clamp portion 204; and a third turn 314C (which is approximately a quarter turn) from the first clamp portion 204 to the first extension portion 208. Alternatively, the second and third turns 314B, 314C could be considered a single U-shaped turn (approximately 180 degrees).

Similarly, the second intermediary passageway 310 comprises corresponding turns, namely first, second and third turns 316A, 316B, 316C.

Referring to FIGS. 7A to 7B, operation of the assembly 10 parting the workpiece 60 is shown.

When the parting-blade 100 is mounted to the holder 12, the assembly directions can be made with either the parting-blade directions or the holder directions, the latter of which was optionally chosen here.

The workpiece 60 has a central workpiece axis AW and during machining is rotated in the counterclockwise direction DCC as indicated.

The holder 12 is shown after it has fully entered the workpiece 60 by moving it in a feed direction corresponding to the holder forward direction DFH (FIG. 7C).

Depth of cut CD (FIG. 7A) for the present embodiment is from the forwardmost cutting edge 34 to a portion of the tool assembly 10 which is wider than the cut width CW of the forwardmost edge 34, i.e., the closest portion of the tool assembly 10 to the cutting edge which is outside of the extended cutting plane. In the example given, and with reference to FIG. 3C, the closest portion of the holder 12 is the concave front surface 44G of the holder 12.

Notably, the first and second clamp portions 204, 206 are outside of the cutting zone ZC and can therefore extend in front of the path of the workpiece 60 as shown in FIG. 7C.

By contrast, to provide coolant proximate to the cutting insert 14, the first and second extension portions 208, 210 are shown extending completely within an elongated slit S formed in the workpiece 60.

In FIG. 7A it is also shown how the extension safety projections 278A, 278B extend below the respective sub-edges and there is a gap G1, G2 between each extension safety projection 278A, 278B and the associated first and second blade safety recesses 132A, 132B.

It will be understood that if the extension safety projections contact the blade safety recesses then this could reduce biasing force between the intended abutment surfaces of the extension portion and blade (particularly, weakening the interlock of the mechanical interlocking structures).

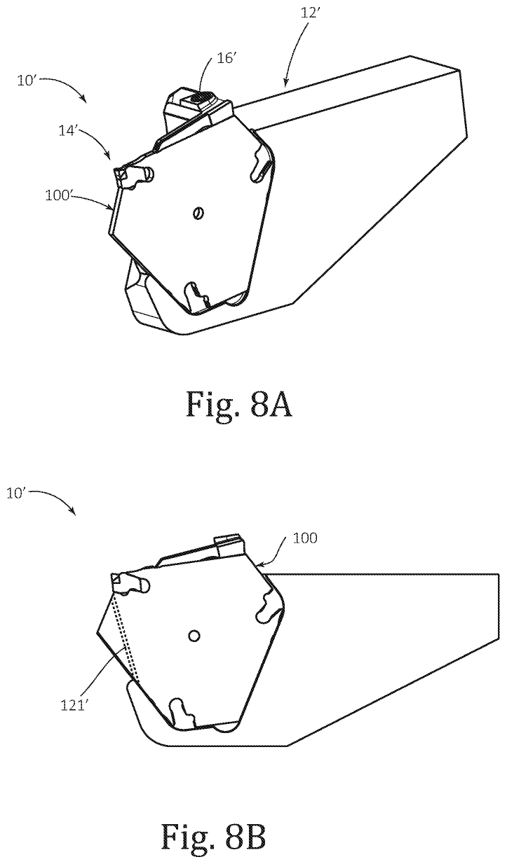

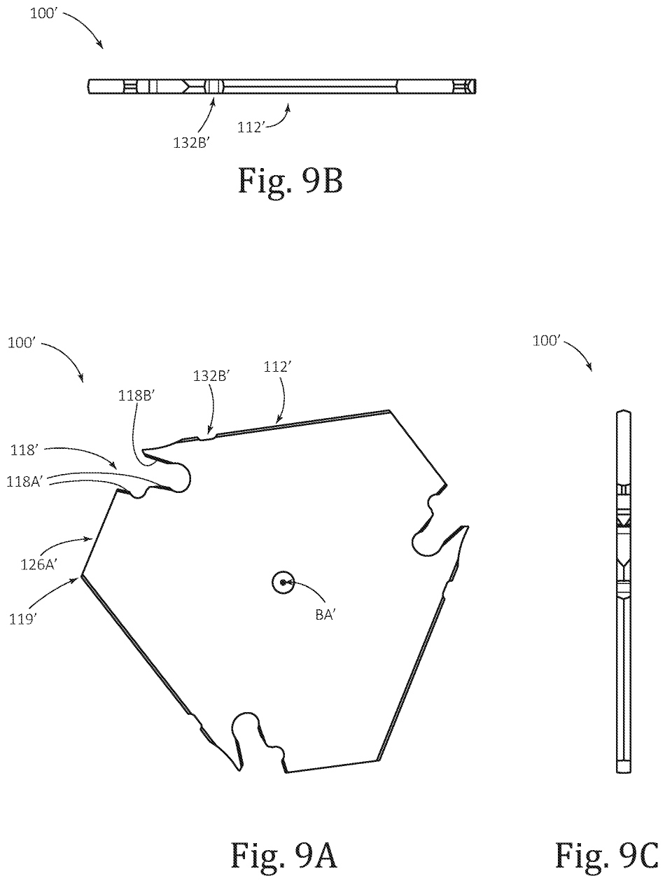

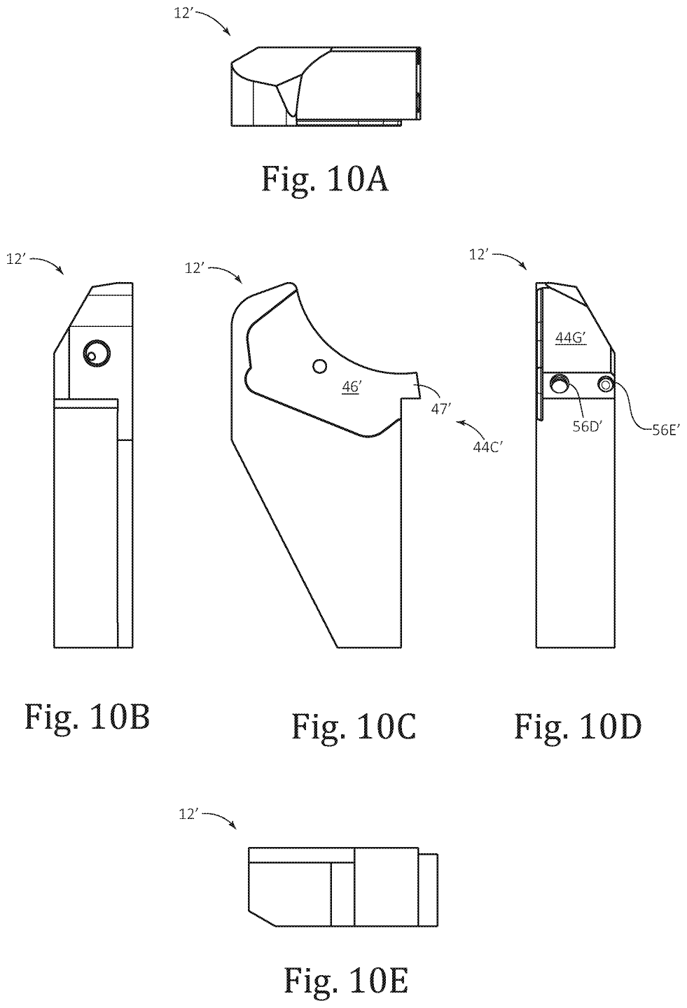

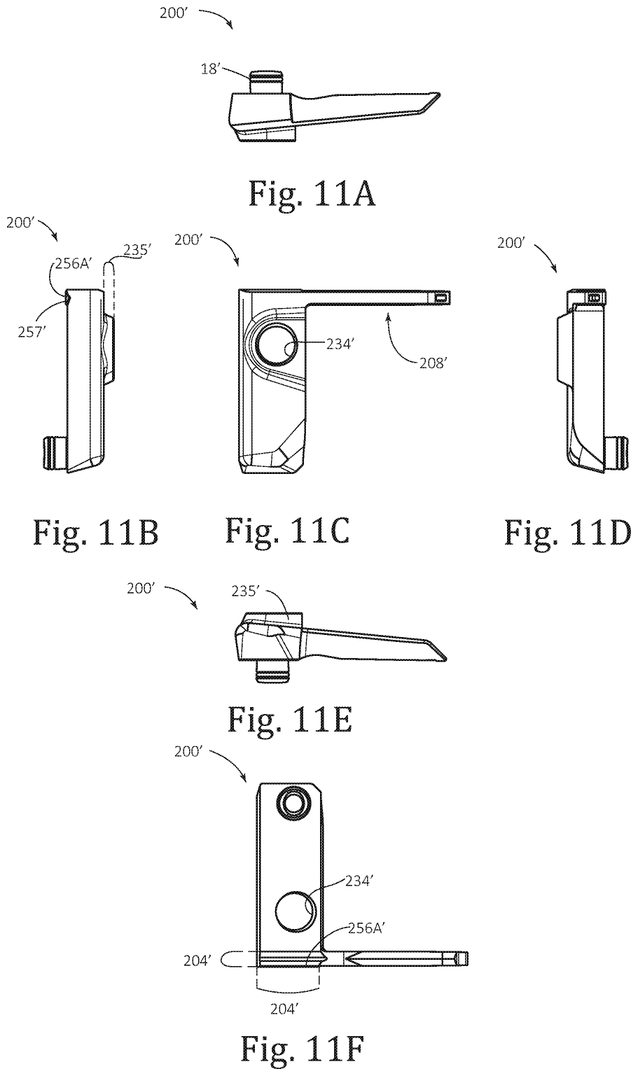

Referring now to FIGS. 8 to 13, there is shown another tool assembly 10′.

The tool assembly 10′ is generally similar to the tool assembly 10 described above except for notable differences which are visible and will briefly be described below.

The tool assembly 10′ comprises a holder 12′, parting-blade 100′ (with a cutting insert 14′ mounted thereto) and parting-blade clamp 200′ clamping the parting-blade 100′ to the holder 12′.

In this particular example, the tool assembly 10′ further comprises a screw 16′, a single o-ring 18′, and a magnet (not shown).

The parting-blade 100′ has a basically triangular shape and is three-way indexable about a central blade axis BA′.

Drawing attention to a first insert pocket 118′ (out of the three insert pockets thereof), it is noted that the second jaw 118B′ is not rearwardly located of the base jaw 118A′ but extends thereabove.

Due to a forward projection 119′ of the parting-blade 100′ (required for mounting purposes), it is difficult to provide coolant to a relief side 126A′ thereof. Thus, in this example, one possible option is to provide a single through-hole 121′ (FIG. 8B) extending through the parting-blade 100. It will be understood that while only one such through-hole 121′ is schematically shown, two more are provided for the other two pockets. Alternatively, the parting-blade can remain without coolant to the relief side 126A′ thereof or perhaps an additional device can be provided below the forward projection 119′.

Accordingly, only a single sub-edge 112′ is provided with a blade safety recess 132B′.

Regarding the holder 12′, it will be noted that there is no groove.

Rather, since the parting-blade clamp 200′ has only a single extension portion 208 and thus only extends to one side of the parting-blade 100′ it can be, in its entirety, on only one side of a cutting zone.

Accordingly, the holder attachment portion 56D′ (which is a similar threaded hole) is located on the holder upper surface 44C′ rearward of the front-surface portion 44G′.

Likewise, the holder outlet 56E′ is located on the holder upper surface 44C′ rearward of the front-surface portion 44G′.

The blade-pocket side surface 46′ comprises an upward projection 47′ to ensure the entire parting-blade 100′ is abutted adjacent to where the clamp portion 204′ abuts the parting-blade 100′.

Regarding the clamp 200′, as mentioned, it is optional to have one or two o-rings 18′ in any embodiment.

The clamp 200′ comprises an attachment portion 234′ similar to that previously described. A reinforcement portion 235′ was added thereabove to ensure clamping forces would be supported.

While the clamp abutment surface 256A′ appears to be V-shaped similar to the formation seen on the second interlocking structure 150, this is only to provide relief. There is only one clamp abutment surface 256A′ with the adjacent surface 257′ being relieved.

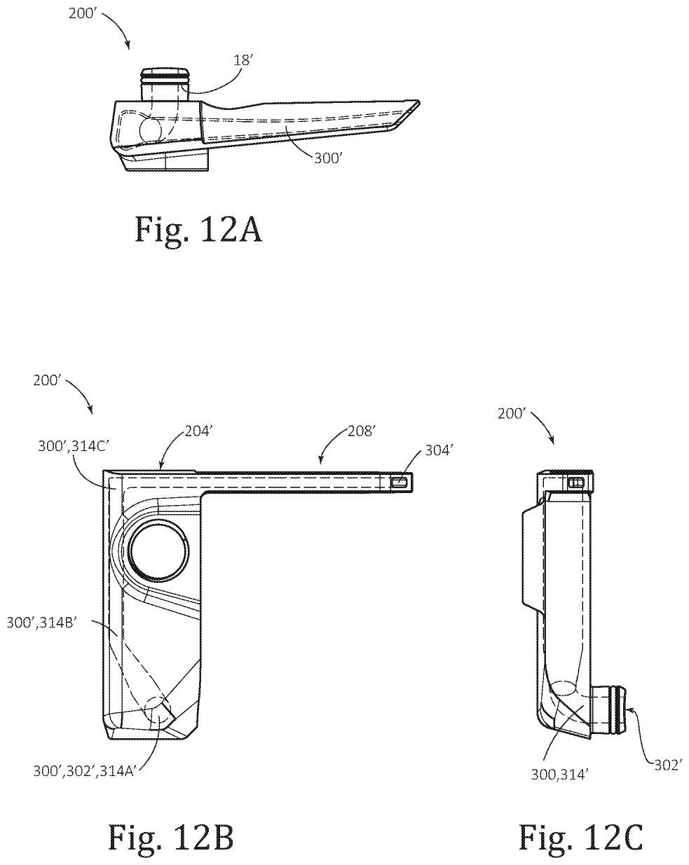

Referring to FIGS. 12A to 12C, the coolant passageway 300′ is seen to have a plurality of turns. More precisely, the intermediary passageway 306′ comprises a first turn 314A′ from the inlet 302′ to the intermediary sub-portion 224; a second turn 314B′ from the body portion 202 to the clamp portion 204′; and a third turn 314C′ (which is approximately a quarter turn) from the clamp portion 204′ to the single extension portion 208′. From the clamp portion 204′ to the first extension portion 208′ and through to the outlet 304′, the coolant path is straight.

It will be noted that the tool assemblies 10, 10′ are advantageous even if their clamps would be free of a coolant passageway. As mentioned above, even the clamping arrangement independently is believed superior over known parting-blade systems.

Standard elongated blades extend from a blade holder without support therebelow (also called “overhang”). They also require large screws to prevent the blade from sliding in the holder, since there is no stopper (called herein a pocket rear abutment surface) to enable the variable overhang length function. In other words, the traditional system uses two opposing (parallel) slanted clamp abutment surfaces (with large screws) to hold a parting-blade.

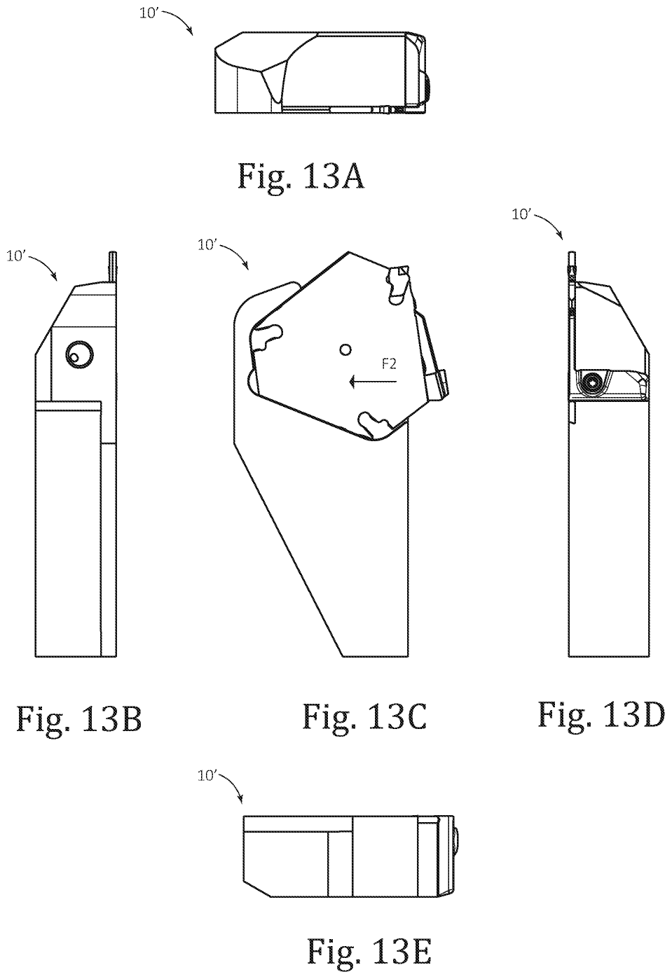

The present invention provides an additional mechanical interlocking structure over the traditional system. More precisely, a first mechanical interlocking structure formed on a clamp (e.g. the first clamp abutment surface 256A or the second clamp abutment surface 256B) can clamp the parting-blade to two non-parallel pocket projecting edges (namely the pocket lower abutment surface 48A and the pocket rear abutment surface 48B, such as seen in FIG. 3C). It will be noted that the present example relies on two clamp abutment surfaces clamping the parting-blade at least partially towards both of the pocket lower abutment surface 48A and the pocket rear abutment surface 48B (i.e. to the area between both and not parallel to one of them; see the clamping force arrow F1 in FIG. 6C). A more relevant example for the direction of a single clamp abutment surface is shown in the following embodiment in FIGS. 8 to 13 (see the clamping force arrow F2 in FIG. 13C, noting that the force does not need to be provided to the center of the two holder abutment surfaces but at least partially to both, even unequally). Nonetheless, it will be understood that even for a square shaped parting-blade, the present embodiment could be modified for a single clamp abutment surface to direct forces towards both holder abutment surfaces. Additionally, such redirection may not be needed since the machining force biases the blade against the pocket lower abutment surface 48A and the pocket rear abutment surface 48B in any case.

This also reduces the two, or more commonly three or four screw systems of the prior art to a single screw, which is hitherto unknown.

Thus, the parting-blade is held securely from three sides instead of two with a single attachment portion. Additionally, mounting the parting-blade is simpler since there is a defined position. One detriment is that the overhang is no longer variable (which allows a user to minimize the overhang per application and increase stability). However, it has been found that the current system has high stability and even with only a single overhang position it is completely stable for desired cut depths.

Said stability is also due to the parting-blade sub-edges (i.e. the third and fourth sub-edges 114, 116) being fully supported along their entire length by the pocket lower abutment surface 48A and the pocket rear abutment surface 48B.

Similar benefits can be found in tool assemblies disclosed in US 2019/0240741 except each assembly disclosed there has other detriments, such as screws or seals which project laterally or in other embodiments an overhanging portion which is not supported. Additionally, the present system provides a clamp with a single attachment portion/screw which is unknown for large cut depth blades.

Further, in tool assembly 10, it is demonstrated that the parting-blade is secured with mechanical interlocking structures from four different sides, providing complete stability. This stability being realized in a tool configured to part a large diameter workpiece while being secured with only a single attachment portion.

Further regarding the clamping, while the extension portions are not configured to bear the entire clamping force, they do bias and hence “pre-load” a parting-blade close to the insert pocket. Thus, additional stability is provided to a relatively thin parting-blade, and at a point closer to an insert pocket than any other known parting-blade system.

Therefore any parting-blade, even one clamped by a traditional blade holder with opposing jaws, or with screws as shown in FIGS. 18 and 19 in US 2019/0240741, or any other known blade, would also benefit in stability by the provision of one or more extension portions which provide a biasing force on the parting-blade along a sub-edge associated with an insert pocket. And this benefit can be realized even with an extension portion devoid of a coolant passageway.

Thus a clamp could have only one or more extension portions, even without a clamp portion and still benefit the stability of a parting-blade (which can of course be an auxiliary clamping arrangement, the assembly further comprising jaws or screws, etc. to provide a main clamping force. Stated differently, the extension portion or portions could provide a clamping function (albeit insufficient), which could be augmented by additional clamping elements such as jaws or screws, etc.

It will be understood that on the one hand, a clamp with both clamp portions and extension portions reduces the number of components to secure, and on the second hand, if an extension portion is separate from a clamp portion and the extension portion is damaged, the clamp portion can independently continue to provide a clamping function.

Finally, it is clear that all of the systems above can additionally benefit from having a coolant passageway therethrough, which in addition to said clamping increases the tool life of a cutting insert, and at high coolant pressures which can assist in chip breakage. It will be noted that the known high-pressure parting-blades cannot reach chip pressure breakage (which by known literature occurs above approximately 100 bar (pressure exiting the parting-blade). This is because there are pressure losses in the blade holder, the transition from the blade holder to the parting-blade, the numerous turns in the blade holder and parting-blade, the small passageways through the parting-blade, etc. The tool assemblies exemplified above, were tested and reached far higher coolant pressures than those created using even so-called high-pressure coolant blades. The higher pressure caused smaller chips to be produced than those produced than at lower coolant pressures.

Finally, it will be noted that such coolant passageway could be provided to a clamp, having one or more clamp portions, yet no extension portions (the coolant simply exiting an outlet formed in the clamp portion). Or to the shown embodiments where there are one or more clamp portions and also one or more extension portions. Or to embodiments (not shown), with one or more extension portions but no clamp portions formed on the same clamp as the extension portions (i.e. the parting-blade be clamped in another manner). In the latter embodiment, the present invention would be directed to a coolant conduit as described above, albeit with one or more unique extension portions.

It will also be noted that the second clamp portion 206 in FIG. 7D extends more in the holder forward direction than the remainder of the tool assembly 10, which is disadvantageous as it increases the length of the tool assembly 10 (reducing the capability to work in restricted areas). Nonetheless, the other advantages provided are believed to outweigh this disadvantage.

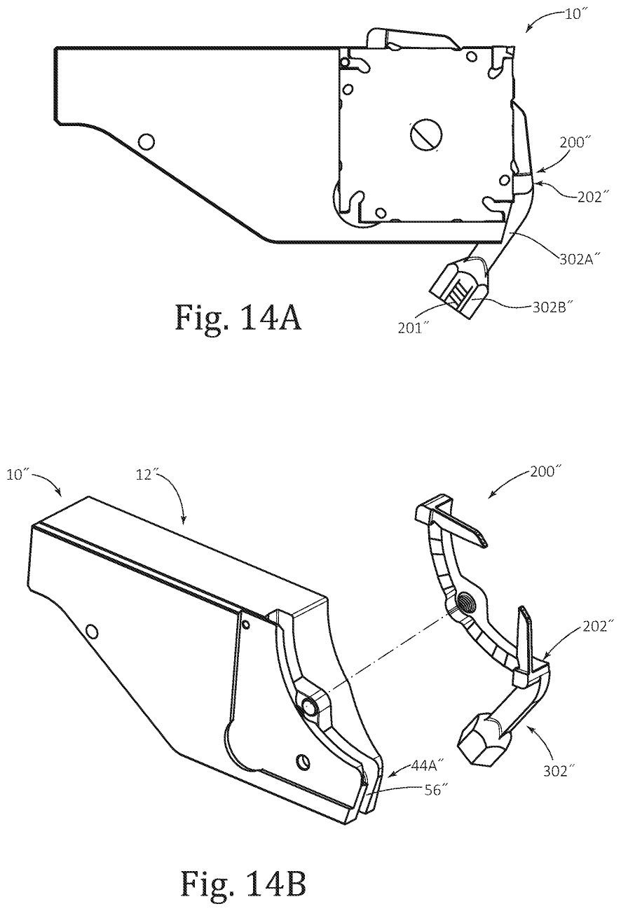

Referring now to FIGS. 14A and 14B, there is shown another tool assembly 10″.

The tool assembly 10″ is generally similar to the tool assembly 10 described above except for notable differences which are visible and will briefly be described below.

In order to provide maximum coolant pressure, the parting-blade clamp 200″ is provided with an inlet 302″ comprising an inlet attachment construction (in this example an internal thread 201″ shown schematically, even though, for example an external threaded connection is also possible.

To elaborate, the inlet 302″ comprises an elongated neck portion 302A″ extending from the body portion 202″ and can optionally be formed with an external securing surface 302B″ (which in this non-limiting example has a hexagonal arrangement but could be any known tool arrangement, e.g. two parallel flat surfaces) to allow a user to hold the inlet 302″ securely when attaching an external supply pipe thereto.

Thus, instead of the holder 12″ being connected to an external supply pipe (not shown) and transferring the coolant to a clamp, the external supply pipe is directly connected to the parting-blade clamp 200″ via the inlet 302″.

This also obviates the need for o-rings and allows a simplified holder construction (without coolant holes).

The only significant modification to the holder 12″ is that the groove 56″ is continued down through the holder front surface 44A″ (and the angle and length of the inlet 302″ allows for the clamp 200″ to be brought from a clamping position to a releasing position).

Such construction can provide a minimum possible pressure drop for an inlet located beneath such holder type, since there are no coolant transfer interfaces between the clamp and holder, etc.

1.-83. (canceled)

84. A parting-off tool assembly comprising:
a blade holder;
a parting-blade; and
a clamp;
the blade holder comprising:
a holder attachment portion; and
a blade-pocket;
the parting blade is mounted to the blade-pocket and comprises:
opposing first and second blade sides and a peripheral blade edge connecting the first and second blade sides; and
at least a first insert pocket being formed along the peripheral blade edge;
the peripheral blade edge comprising:
first and second blade sub-edges extending from different sides of the first insert pocket;
the clamp comprising:
a clamp attachment portion;
at least one clamp portion comprising a clamp abutment surface; and
at least a first extension portion which is elongated along a common plane with the parting-blade;
wherein:
the clamp attachment portion is fastened to the holder attachment portion;
the clamp abutment surface abuts the peripheral blade edge of the parting-blade, thereby securing the parting-blade to the blade-pocket; and
the first extension portion abuts the peripheral blade edge.

85. The parting-off tool assembly according to claim 1, further comprising a cutting insert mounted to the insert pocket and the cutting width thereof defines an extended-width cutting plane PC, and wherein the entire first extension portion lies only within an extended-width cutting plane PC.

86. The parting-off tool assembly according to claim 1, wherein each of the clamp abutment surface and the first extension portion comprising abutment surfaces located in a common cutting plane; the extension portion's abutment surface being located relatively lower in the cutting plane such that when both of the abutment surfaces contact the parting-blade's peripheral edge the first extension portion flexes.

87. The parting-off tool assembly according to claim 1, wherein the first extension portion comprises a distal extension end closer to the insert pocket than a proximal extension end of the first extension portion, and only the distal extension end is biased against the parting-blade's peripheral edge.

88. The parting-off tool assembly according to any claim 1, wherein the first extension portion is biased against the parting-blade's peripheral edge at a rake side of the parting-blade relative to the insert pocket; or wherein the first extension portion is biased against the parting-blade's peripheral edge at a relief side of the parting-blade relative to the insert pocket.

89. The parting-off tool assembly according to claim 1, wherein a maximum extension portion height HE, defined perpendicular to an elongation direction of the first extension portion and a maximum extension thickness TE fulfills the condition: 1.5TE<HE<8TE.

90. The parting-off tool assembly according to claim 1, wherein the parting-blade has a thickness dimension DT perpendicular to the first and second blade sides, and the first extension portion has an extension thickness TE which is less than the blade's thickness dimension DT.

91. The parting-off tool assembly according to claim 1, wherein the first extension portion is elongated such that a maximum length LM to maximum height HE fulfills the condition: LM>HE.

92. The parting-off tool assembly according to claim 1, wherein the first extension portion comprises a safety projection or safety recess and the parting-blade comprises a complementary safety projection or safety recess.

93. The parting-off tool assembly according to claim 92, wherein the first extension portion comprises a safety projection extending from an inner extension surface thereof, which is accommodated within the safety recess of the parting-blade without contacting the parting-blade.

94. The parting-off tool assembly according to claim 1, wherein the first extension portion comprises a mechanical interlocking structure and is biased against a complementary mechanical interlocking structure formed along the parting blade's peripheral edge.

95. The parting-off tool assembly according to claim 1, wherein the clamp comprises: a second clamp portion comprising a second clamp abutment surface extending in a different direction to the other clamp abutment surface; wherein: the second clamp abutment surface abuts the peripheral edge of the parting-blade thereby securing the parting-blade to the blade-pocket.

96. The parting-off tool assembly according to claim 1, wherein the clamp further comprises: a body portion comprising a first body end, a second body end and an intermediary body sub-portion connecting the first end and second end; said clamp attachment portion is connected to the body portion; said clamp portion constitutes a first clamp portion connected to the first end; and a coolant passageway; the coolant passageway comprising: an inlet; a first outlet; and an intermediary passageway extending from the inlet to the first outlet; and the first outlet opens out to the first extension portion.

97. The parting-off tool assembly according to claim 96, wherein the coolant passageway, from the inlet, forks in two different directions.

98. The parting-off tool assembly according to claim 96, wherein the clamp is configured for direct connection to a supply pipe.

99. The parting-off tool assembly according to claim 96, wherein the first extension portion is linear-shaped proximate to the insert pocket and the front extension surface is slanted relative to the linear direction.

100. The parting-off tool assembly according to claim 1, wherein the clamp has two extension portions and is designed symmetrically.

101. The parting-off tool assembly according to claim 1, wherein the clamp comprises a second extension portion being elongated along a common plane with the parting-blade.

102. The parting-off tool assembly according to claim 101, wherein the first and second extension portions are configured to extend along two non-parallel blade-sub edges of the peripheral blade edge.

103. The parting-off tool assembly according to claim 101, wherein the parting-blade is wedged against a pocket projecting edge of the blade-pocket, between two extension portions of the clamp, the two extension portions comprising mechanical interlocking structures.

104. The parting-off tool assembly according to claim 1, wherein the parting-blade is wedged against a pocket projecting edge of the blade-pocket, between two clamp portions of the clamp.

105. The parting-off tool assembly according to claim 1, wherein at least one or both of the first blade sub-edge and the second blade sub-edge is formed with a blade safety recess.

106. The parting-off tool assembly according to claim 105, wherein there is a blade safety recess formed at both the rake and relief sides of the parting-blade relative to the insert pocket, and the blade safety recesses are equally spaced from the insert pocket.

107. The parting-off tool assembly according to claim 1, wherein the first insert pocket comprises: a base jaw; a second jaw; and a slot end connecting the base jaw and the second jaw; wherein: the base jaw is closer than the second jaw to the first blade sub-edge; the second jaw is closer than the base jaw to the second blade sub-edge; and wherein at least one of the following two conditions is fulfilled: a first condition wherein the second blade sub-edge is longer than the first blade sub-edge; and the first blade sub-edge is formed with a first blade mechanical interlocking structure; and a second condition wherein both the first blade sub-edge and the second blade sub-edge are both formed with a blade mechanical interlocking structure.

108. The parting-off tool assembly according to claim 1, wherein either: the first blade sub-edge is formed with a first blade mechanical interlocking structure; the second blade sub-edge are both formed with a blade mechanical interlocking structure; or both the first and second blade sub-edges are formed with blade mechanical interlocking structures.

109. The parting-off tool assembly according to claim 1, wherein the parting blade is devoid of internal coolant channels.

110. The parting-off tool assembly according to claim 1, wherein the parting-blade is devoid of threaded holes.

111. The parting-off tool assembly according to claim 1, wherein the blade-pocket comprises a magnet attached thereto.

112. The parting-off tool assembly according to claim 1, wherein the blade pocket comprises: a blade-pocket side surface; a pocket projecting edge extending from the blade-pocket side surface; the pocket projecting edge comprising a first abutment sub-surface and a second abutment sub-surface extending in a different direction to the first abutment sub-surface; and wherein both the first abutment sub-surface and a second abutment sub-surface are slanted towards the blade-pocket side surface.
